(19) United States
(12) Patent Application Publication
(10) Pub. No.: US 2026/0368513 A1
(43) Pub. Date: Nov. 19, 2026

(54) APPARATUS AND METHOD FOR PERFORMING ONLINE LEARNING OF TRANSCEIVER MODEL IN WIRELESS COMMUNICATION SYSTEM

(71) Applicant: LG Electronics Inc., Seoul (KR)

(72) Inventors: Kyungho LEE, Seoul (KR); Bonghoe KIM, Seoul (KR); Sangrim LEE, Seoul (KR)

(21) Appl. No.: 18/707,835

(22) PCT Filed: Nov. 24, 2022
(86) PCT No.: PCT/KR2022/018697

§ 371 Date: Jul. 29, 2026

(30) Foreign Application Priority Data
Dec. 13, 2021 (KR) 10-2021-0177975

(51) Int. Cl. G06N 3/08; H04L 5/00

(52) U.S. Cl. CPC G06N 3/08; H04L 5/0094

(57) ABSTRACT

Performing online learning for a transceiver model in a wireless communication system, and a method performed by a user equipment (UE) in a wireless communication system may include receiving configuration information related to reference signals, receiving first reference signals, transmitting first feedback information corresponding to the first reference signals, receiving second reference signals, and transmitting second feedback information corresponding to the second reference signals. The first reference signals and the second reference signals may be used to configure at least one parameter related to a receiver for processing a received signal, and the configuration information may include at least one of tasks used for meta learning, a batch size for training, an optimizing method for a parameter of a model in the receiver, at least one task used for an inner loop, or at least one task used for an outer loop.

### TECHNICAL FIELD

The present disclosure relates to a wireless communication system, and more particularly, to a device and method for performing online learning for a transceiver model in a wireless communication system.

### BACKGROUND ART

Wireless communication systems have been widely deployed to provide various types of communication services such as voice or data. In general, a wireless communication system is a multiple access system that supports communication of multiple users by sharing available system resources (a bandwidth, transmission power, etc.). Examples of multiple access systems include a code division multiple access (CDMA) system, a frequency division multiple access (FDMA) system, a time division multiple access (TDMA) system, an orthogonal frequency division multiple access (OFDMA) system, and a single carrier frequency division multiple access (SC-FDMA) system.

In particular, as a large number of communication devices require a large communication capacity, the enhanced mobile broadband (eMBB) communication technology, as compared to the conventional radio access technology (RAT), is being proposed. In addition, not only massive machine type communications (massive MTC), which provide a variety of services anytime and anywhere by connecting multiple devices and objects, but also a communication system considering a service/user equipment (UE) sensitive to reliability and latency is being proposed. Various technical configurations for this are being proposed.

### DISCLOSURE

### Technical Problem

The present disclosure may provide a device and method for effectively performing online learning for a transceiver model in a wireless communication system.

The present disclosure may provide a device and method for performing meta learning for a transceiver model in a wireless communication system.

The present disclosure may provide a device and method for determining a meta model parameter for a transceiver model in a wireless communication system.

The present disclosure may provide a device and method for reducing overhead for meta learning for a transceiver model in a wireless communication system.

The present disclosure may provide a device and method for transmitting reference signals for meta learning for a receiver model in a wireless communication system.

The present disclosure may provide a device and method for giving feedback on loss information for meta learning for a sender model in a wireless communication system.

The present disclosure may provide a device and method for giving feedback on loss information for some tasks for meta learning for a sender model in a wireless communication system.

The present disclosure may provide a device and method for selecting some tasks capable of representing a meta model parameter in a wireless communication system.

The present disclosure may provide a device and method for clustering model parameters according to each task in a wireless communication system.

Technical objects to be achieved in the present disclosure are not limited to what is mentioned above, and other technical objects not mentioned therein can be considered from the embodiments of the present disclosure to be described below by those skilled in the art to which a technical configuration of the present disclosure is applied.

### Technical Solution

According to an example of the present disclosure, a method for operating a user equipment (UE) in a wireless communication system may include receiving configuration information related to reference signals, receiving first reference signals, transmitting first feedback information corresponding to the first reference signals, receiving second reference signals, and transmitting second feedback information corresponding to the second reference signals. The first reference signals and the second reference signals may be used to configure at least one parameter related to a receiver for processing a received signal, and the configuration information may include at least one of tasks used for meta learning, a batch size for training, an optimizing method for a parameter of a model in the receiver, at least one task used for an inner loop, or at least one task used for an outer loop.

According to an example of the present disclosure, a method for operating a base station in a wireless communication system may transmitting configuration information related to reference signals, transmitting first reference signals, receiving first feedback information corresponding to the first reference signals, transmitting second reference signals, and receiving second feedback information corresponding to the second reference signals. The first reference signals and the second reference signals may be used to configure at least one parameter related to a sender for processing a transmitted signal, and the configuration information may include at least one of tasks used for meta learning, a batch size for training, an optimizing method for a parameter of a model in a receiver of a user equipment (UE), at least one task used for an inner loop, or at least one task used for an outer loop.

According to an example of the present disclosure, a user equipment (UE) in a wireless communication system may include a transceiver and a processor coupled with the transceiver, the processor may be configured to receive configuration information related to reference signals, to receive first reference signals, to transmit first feedback information corresponding to the first reference signals, to receive second reference signals, and to transmit second feedback information corresponding to the second reference signals, the first reference signals and the second reference signals may be used to configure at least one parameter related to a receiver for processing a received signal, and the configuration information may include at least one of tasks used for meta learning, a batch size for training, an optimizing method for a parameter of a model in the receiver, at least one task used for an inner loop, or at least one task used for an outer loop.

According to an example of the present disclosure, a base station in a wireless communication system may include a transceiver and a processor coupled with the transceiver, the processor may be configured to transmit configuration information related to reference signals, to transmit first reference signals, to receive first feedback information corresponding to the first reference signals, to transmit second reference signals, and to receive second feedback information corresponding to the second reference signals, the first reference signals and the second reference signals may be used to configure at least one parameter related to a sender for processing a transmitted signal, and the configuration information may include at least one of tasks used for meta learning, a batch size for training, an optimizing method for a parameter of a model in a receiver of a user equipment (UE), at least one task used for an inner loop, or at least one task used for an outer loop.

According to an example of the present disclosure, a communication device may include at least one processor and at least one computer memory coupled with the at least one processor and storing an instruction instructing operations when executed by the at least one processor, and the operations may include receiving configuration information related to reference signals, receiving first reference signals, transmitting first feedback information corresponding to the first reference signals, receiving second reference signals, and transmitting second feedback information corresponding to the second reference signals. The first reference signals and the second reference signals may be used to configure at least one parameter related to a receiver for processing a received signal, and the configuration information may include at least one of tasks used for meta learning, a batch size for training, an optimizing method for a parameter of a model in the receiver, at least one task used for an inner loop, or at least one task used for an outer loop.

According to an example of the present disclosure, a non-transitory computer-readable medium storing at least one instruction may include the at least one instruction executable by a processor, the at least one instruction may control a device to receive configuration information related to reference signals, to receive first reference signals, to transmit first feedback information corresponding to the first reference signals, to receive second reference signals, and to transmit second feedback information corresponding to the second reference signals, the first reference signals and the second reference signals may be used to configure at least one parameter related to a receiver for processing a received signal, and the configuration information may include at least one of tasks used for meta learning, a batch size for training, an optimizing method for a parameter of a model in the receiver, at least one task used for an inner loop, or at least one task used for an outer loop.

The above-described aspects of the present disclosure are merely some of the preferred embodiments of the present disclosure, and various embodiments reflecting the technical features of the present disclosure may be derived and understood by those of ordinary skill in the art based on the following detailed description of the disclosure.

### Advantageous Effects

As is apparent from the above description, the embodiments of the present disclosure have the following effects.

According to the present disclosure, online learning for a transceiver model, particularly, meta learning may be effectively performed.

That is, effects, which are not intended when implementing a configuration described in the present disclosure, may also be derived by those skilled in the art from the embodiments of the present disclosure.

### DESCRIPTION OF DRAWINGS

The accompanying drawings are provided to aid understanding of the present disclosure, and embodiments of the present disclosure may be provided together with a detailed description. However, the technical features of the present disclosure are not limited to a specific drawing, and features disclosed in each drawing may be combined with each other to constitute anew embodiment. Reference numerals in each drawing may mean structural elements.

FIG. 1 illustrates an example of a communication system applicable to the present disclosure.

FIG. 2 illustrates an example of a wireless apparatus applicable to the present disclosure.

FIG. 3 illustrates another example of a wireless device applicable to the present disclosure.

FIG. 4 illustrates an example of a hand-held device applicable to the present disclosure.

FIG. 5 illustrates an example of a car or an autonomous driving car applicable to the present disclosure.

FIG. 6 illustrates an example of artificial intelligence (AI) device applicable to the present disclosure.

FIG. 7 illustrates a method of processing a transmitted signal applicable to the present disclosure.

FIG. 8 illustrates an example of a communication structure providable in a 6th generation (6G) system applicable to the present disclosure.

FIG. 9 illustrates an electromagnetic spectrum applicable to the present disclosure.

FIG. 10 illustrates a THz communication method applicable to the present disclosure.

FIG. 11 illustrates a perceptron architecture in an artificial neural network applicable to the present disclosure.

FIG. 12 illustrates an artificial neural network architecture applicable to the present disclosure.

FIG. 13 illustrates a deep neural network applicable to the present disclosure.

FIG. 14 illustrates a convolutional neural network applicable to the present disclosure.

FIG. 15 illustrates a filter operation of a convolutional neural network applicable to the present disclosure.

FIG. 16 illustrates a neural network architecture with a recurrent loop applicable to the present disclosure.

FIG. 17 illustrates an operational structure of a recurrent neural network applicable to the present disclosure.

FIG. 18 illustrates a concept of meta learning applicable to the present disclosure.

FIG. 19A and FIG. 19B illustrate examples of data sets for meta learning applicable to the present disclosure.

FIG. 20 illustrates functional structures of devices for supporting meta learning according to an embodiment of the present disclosure.

FIG. 21 illustrates a procedure of determining a parameter related to a sender according to an embodiment of the present disclosure.

FIG. 22 illustrates a procedure of determining a parameter related to a receiver according to an embodiment of the present disclosure.

FIG. 23 illustrates an example of a procedure for performing meta learning for a receiver according to an embodiment of the present disclosure.

FIG. 24 illustrates an example of a procedure for performing meta learning for a sender according to an embodiment of the present disclosure.

FIG. 25 illustrates another example of a procedure for performing meta learning for a sender according to an embodiment of the present disclosure.

FIG. 26 illustrates an example of clustering for model parameters according to an embodiment of the present disclosure.

### MODE FOR INVENTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a base station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. The term “BS” may be replaced with a fixed station, a Node B, an evolved Node B (eNode B or eNB), an advanced base station (ABS), an access point, etc.

In the embodiments of the present disclosure, the term terminal may be replaced with a UE, a mobile station (MS), a subscriber station (SS), a mobile subscriber station (MSS), a mobile terminal, an advanced mobile station (AMS), etc.

A transmitter is a fixed and/or mobile node that provides a data service or a voice service and a receiver is a fixed and/or mobile node that receives a data service or a voice service. Therefore, a mobile station may serve as a transmitter and a BS may serve as a receiver, on an uplink (UL). Likewise, the mobile station may serve as a receiver and the BS may serve as a transmitter, on a downlink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 36.211, 3GPP TS 36.212, 3GPP TS 36.213, 3GPP TS 36.321 and 3GPP TS 36.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as code division multiple access (CDMA), frequency division multiple access (FDMA), time division multiple access (TDMA), orthogonal frequency division multiple access (OFDMA), single carrier frequency division multiple access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology TS Release 17 and/or Release 18. “xxx” may refer to a detailed number of a standard document. LTE/NR/6G may be collectively referred to as a 3GPP system.

For background arts, terms, abbreviations, etc. used in the present disclosure, refer to matters described in the standard documents published prior to the present disclosure. For example, reference may be made to the standard documents 36.xxx and 38.xxx.

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

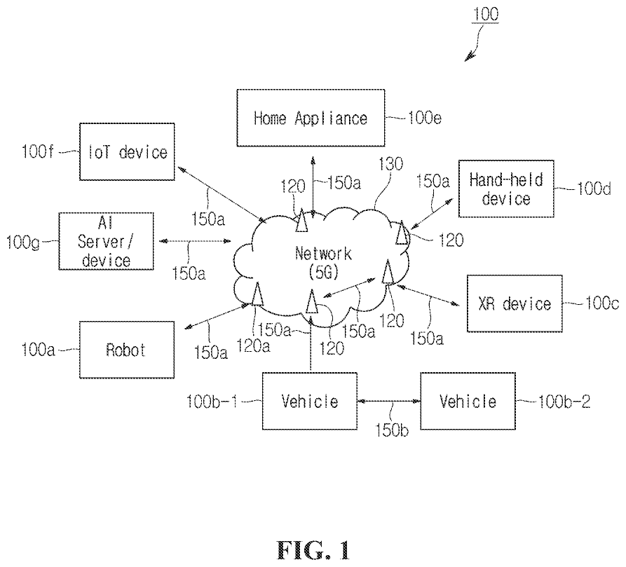

FIG. 1 illustrates an example of a communication system applicable to the present disclosure.

Referring to FIG. 1, the communication system 100 applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include a robot 100a, vehicles 100b-1 and 100b-2, an extended reality (XR) device 100c, a hand-held device 100d, a home appliance 100e, an Internet of Thing (IoT) device 100f, and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120 and the network 130 may be implemented by a wireless device, and a specific wireless device 120a may operate as a base station/network node for another wireless device.

The wireless devices 100a to 100f may be connected to the network 130 through the base station 120. AI technology is applicable to the wireless devices 100a to 100f, and the wireless devices 100a to 100f may be connected to the AI server 100g through the network 130. The network 130 may be configured using a 3G network, a 4G (e.g., LTE) network or a 5G (e.g., NR) network, etc. The wireless devices 100a to 100f may communicate with each other through the base station 120/the network 130 or perform direct communication (e.g., sidelink communication) without through the base station 120/the network 130. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

Wireless communications/connections 150a, 150b and 150c may be established between the wireless devices 100a to 100f/the base station 120 and the base station 120/the base station 120. Here, wireless communication/connection may be established through various radio access technologies (e.g., 5G NR) such as uplink/downlink communication 150a, sidelink communication 150b (or D2D communication) or communication 150c between base stations (e.g., relay, integrated access backhaul (IAB). The wireless device and the base station/wireless device or the base station and the base station may transmit/receive radio signals to/from each other through wireless communication/connection 150a, 150b and 150c. For example, wireless communication/connection 150a, 150b and 150c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.), resource allocation processes, etc. may be performed.

### Communication System Applicable to the Present Disclosure

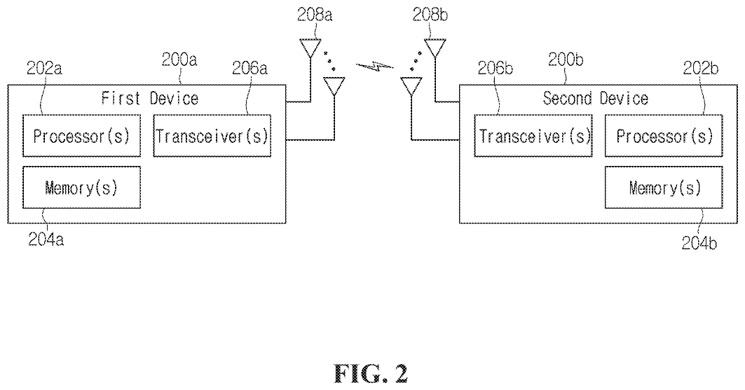

FIG. 2 illustrates an example of a wireless device applicable to the present disclosure.

Referring to FIG. 2, a first wireless device 200a and a second wireless device 200b may transmit and receive radio signals through various radio access technologies (e.g., LTE or NR). Here, {the first wireless device 200a, the second wireless device 200b} may correspond to {the wireless device 100x, the base station 120} and/or {the wireless device 100x, the wireless device 100x} of FIG. 1.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be coupled with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be coupled with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

The second wireless device 200b may include one or more processors 202b and one or more memories 204b and may further include one or more transceivers 206b and/or one or more antennas 208b. The processor 202b may be configured to control the memory 204b and/or the transceiver 206b and to implement the descriptions, functions, procedures, proposals, methods and/or operational flowcharts disclosed herein. For example, the processor 202b may process information in the memory 204b to generate third information/signal and then transmit the third information/signal through the transceiver 206b. In addition, the processor 202b may receive a radio signal including fourth information/signal through the transceiver 206b and then store information obtained from signal processing of the fourth information/signal in the memory 204b. The memory 204b may be coupled with the processor 202b to store a variety of information related to operation of the processor 202b. For example, the memory 204b may store software code including instructions for performing all or some of the processes controlled by the processor 202b or performing the descriptions, functions, procedures, proposals, methods and/or operational flowcharts disclosed herein. Herein, the processor 202b and the memory 204b may be part of a communication modem/circuit/chip designed to implement wireless communication technology (e.g., LTE or NR). The transceiver 206b may be coupled with the processor 202b to transmit and/or receive radio signals through one or more antennas 208b. The transceiver 206b may include a transmitter and/or a receiver. The transceiver 206b may be used interchangeably with a radio frequency (RF) unit. In the present disclosure, the wireless device may refer to a communication modem/circuit/chip.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202a and 202b may generate one or more protocol data units (PDUs) and/or one or more service data unit (SDU) according to the descriptions, functions, procedures, proposals, methods and/or operational flowcharts disclosed herein. One or more processors 202a and 202b may generate messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals and/or methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

One or more memories 204a and 204b may be coupled with one or more processors 202a and 202b to store various types of data, signals, messages, information, programs, code, instructions and/or commands. One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be coupled with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc. described in the methods and/or operational flowcharts of the present disclosure from one or more other apparatuses. For example, one or more transceivers 206a and 206b may be coupled with one or more processors 202a and 202b to transmit/receive radio signals. For example, one or more processors 202a and 202b may perform control such that one or more transceivers 206a and 206b transmit user data, control information or radio signals to one or more other apparatuses. In addition, one or more processors 202a and 202b may perform control such that one or more transceivers 206a and 206b receive user data, control information or radio signals from one or more other apparatuses. In addition, one or more transceivers 206a and 206b may be coupled with one or more antennas 208a and 208b, and one or more transceivers 206a and 206b may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters.

### Structure of Wireless Device Applicable to the Present Disclosure

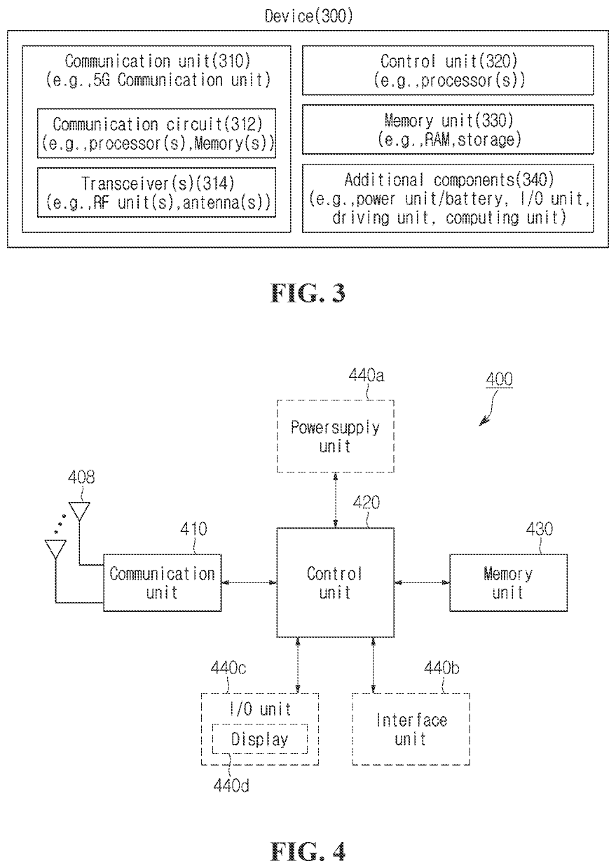

FIG. 3 illustrates another example of a wireless device applicable to the present disclosure.

Referring to FIG. 3, a wireless device 300 may correspond to the wireless devices 200a and 200b of FIG. 2 and include various elements, components, units/portions and/or modules. For example, the wireless device 300 may include a communication unit 310, a control unit (controller) 320, a memory unit (memory) 330 and additional components 340. The communication unit may include a communication circuit 312 and a transceiver(s) 314. For example, the communication circuit 312 may include one or more processors 202a and 202b and/or one or more memories 204a and 204b of FIG. 2. For example, the transceiver(s) 314 may include one or more transceivers 206a and 206b and/or one or more antennas 208a and 208b of FIG. 2. The control unit 320 may be electrically coupled with the communication unit 310, the memory unit 330 and the additional components 340 to control overall operation of the wireless device. For example, the control unit 320 may control electrical/mechanical operation of the wireless device based on a program/code/instruction/information stored in the memory unit 330. In addition, the control unit 320 may transmit the information stored in the memory unit 330 to the outside (e.g., another communication device) through the wireless/wired interface using the communication unit 310 over a wireless/wired interface or store information received from the outside (e.g., another communication device) through the wireless/wired interface using the communication unit 310 in the memory unit 330.

The additional components 340 may be variously configured according to the types of the wireless devices. For example, the additional components 340 may include at least one of a power unit/battery, an input/output unit, a driving unit or a computing unit. Without being limited thereto, the wireless device 300 may be implemented in the form of the robot (FIG. 1, 100a), the vehicles (FIG. 1, 100b-1 and 100b-2), the XR device (FIG. 1, 100c), the hand-held device (FIG. 1, 100d), the home appliance (FIG. 1, 100e), the IoT device (FIG. 1, 100f), a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 3, various elements, components, units/portions and/or modules in the wireless device 300 may be coupled with each other through wired interfaces or at least some thereof may be wirelessly coupled through the communication unit 310. For example, in the wireless device 300, the control unit 320 and the communication unit 310 may be coupled by wire, and the control unit 320 and the first unit (e.g., 130 or 140) may be wirelessly coupled through the communication unit 310. In addition, each element, component, unit/portion and/or module of the wireless device 300 may further include one or more elements. For example, the control unit 320 may be composed of a set of one or more processors. For example, the control unit 320 may be composed of a set of a communication control processor, an application processor, an electronic control unit (ECU), a graphic processing processor, a memory control processor, etc. In another example, the memory unit 330 may be composed of a random access memory (RAM), a dynamic RAM (DRAM), a read only memory (ROM), a flash memory, a volatile memory, a non-volatile memory and/or a combination thereof.

### Hand-Held Device Applicable to the Present Disclosure

FIG. 4 illustrates an example of a hand-held device applicable to the present disclosure.

FIG. 4 shows a hand-held device applicable to the present disclosure. The hand-held device may include a smartphone, a smart pad, a wearable device (e.g., a smart watch or smart glasses), and a hand-held computer (e.g., a laptop, etc.). The hand-held device may be referred to as a mobile station (MS), a user terminal (UT), a mobile subscriber station (MSS), a subscriber station (SS), an advanced mobile station (AMS) or a wireless terminal (WT).

Referring to FIG. 4, the hand-held device 400 may include an antenna unit (antenna) 408, a communication unit (transceiver) 410, a control unit (controller) 420, a memory unit (memory) 430, a power supply unit (power supply) 440a, an interface unit (interface) 440b, and an input/output unit 440c. An antenna unit (antenna) 408 may be part of the communication unit 410. The blocks 410 to 430/440a to 440c may correspond to the blocks 310 to 330/340 of FIG. 3, respectively.

The communication unit 410 may transmit and receive signals (e.g., data, control signals, etc.) to and from other wireless devices or base stations. The control unit 420 may control the components of the hand-held device 400 to perform various operations. The control unit 420 may include an application processor (AP). The memory unit 430 may store data/parameters/program/code/instructions necessary to drive the hand-held device 400. In addition, the memory unit 430 may store input/output data/information, etc. The power supply unit 440a may supply power to the hand-held device 400 and include a wired/wireless charging circuit, a battery, etc. The interface unit 440b may support connection between the hand-held device 400 and another external device. The interface unit 440b may include various ports (e.g., an audio input/output port and a video input/output port) for connection with the external device. The input/output unit 440c may receive or output video information/signals, audio information/signals, data and/or user input information. The input/output unit 440c may include a camera, a microphone, a user input unit, a display 440d, a speaker and/or a haptic module.

For example, in case of data communication, the input/output unit 440c may acquire user input information/signal (e.g., touch, text, voice, image or video) from the user and store the user input information/signal in the memory unit 430. The communication unit 410 may convert the information/signal stored in the memory into a radio signal and transmit the converted radio signal to another wireless device directly or transmit the converted radio signal to a base station. In addition, the communication unit 410 may receive a radio signal from another wireless device or the base station and then restore the received radio signal into original information/signal. The restored information/signal may be stored in the memory unit 430 and then output through the input/output unit 440c in various forms (e.g., text, voice, image, video and haptic).

### Type of Wireless Device Applicable to the Present Disclosure

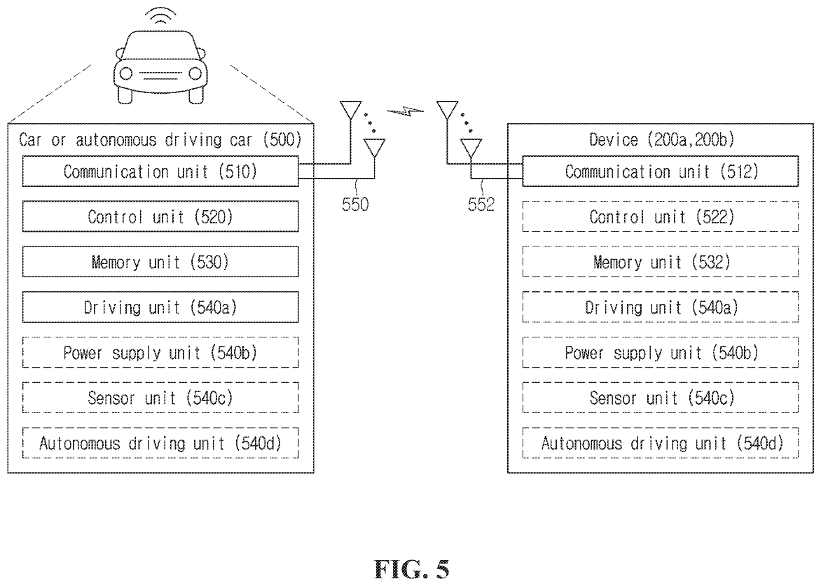

FIG. 5 illustrates an example of a car or an autonomous driving car applicable to the present disclosure.

FIG. 5 shows a car or an autonomous driving vehicle applicable to the present disclosure. The car or the autonomous driving car may be implemented as a mobile robot, a vehicle, a train, a manned/unmanned aerial vehicle (AV), a ship, etc. and the type of the car is not limited.

Referring to FIG. 5, the car or autonomous driving car 500 may include an antenna unit (antenna) 508, a communication unit (transceiver) 510, a control unit (controller) 520, a driving unit 540a, a power supply unit (power supply) 540b, a sensor unit 540c, and an autonomous driving unit 540d. The antenna unit 550 may be configured as part of the communication unit 510. The blocks 510/530/540a to 540d correspond to the blocks 410/430/440 of FIG. 4.

The communication unit 510 may transmit and receive signals (e.g., data, control signals, etc.) to and from external devices such as another vehicle, a base station (e.g., a base station, a road side unit, etc.), and a server. The control unit 520 may control the elements of the car or autonomous driving car 500 to perform various operations. The control unit 520 may include an electronic control unit (ECU).

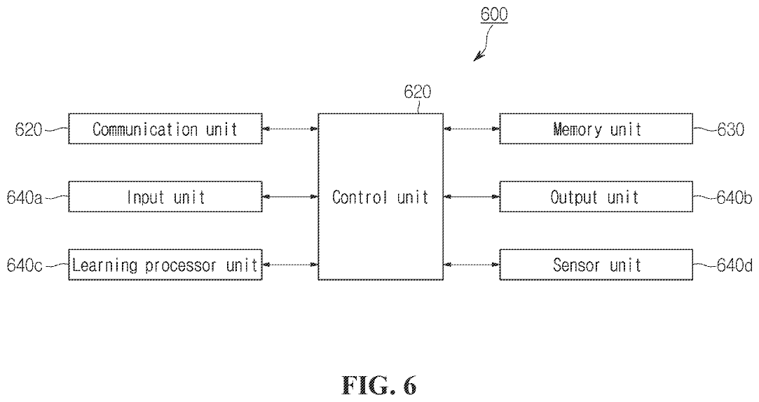

FIG. 6 illustrates an example of artificial intelligence (AI) device applicable to the present disclosure. For example, the AI device may be implemented as fixed or movable devices such as a TV, a projector, a smartphone, a PC, a laptop, a digital broadcast terminal, a tablet PC, a wearable device, a set-top box (STB), a radio, a washing machine, a refrigerator, a digital signage, a robot, a vehicle, or the like.

Referring to FIG. 6, the AI device 600 may include a communication unit (transceiver) 610, a control unit (controller) 620, a memory unit (memory) 630, an input/output unit 640a/640b, a leaning processor unit (learning processor) 640c and a sensor unit 640d. The blocks 610 to 630/640a to 640d may correspond to the blocks 310 to 330/340 of FIG. 3, respectively.

The communication unit 610 may transmit and receive wired/wireless signals (e.g., sensor information, user input, learning models, control signals, etc.) to and from external devices such as another AI device (e.g., FIG. 1, 100x, 120 or 140) or the AI server (FIG. 1, 140) using wired/wireless communication technology. To this end, the communication unit 610 may transmit information in the memory unit 630 to an external device or transfer a signal received from the external device to the memory unit 630.

The control unit 620 may determine at least one executable operation of the AI device 600 based on information determined or generated using a data analysis algorithm or a machine learning algorithm. In addition, the control unit 620 may control the components of the AI device 600 to perform the determined operation. For example, the control unit 620 may request, search for, receive or utilize the data of the learning processor unit 640c or the memory unit 630, and control the components of the AI device 600 to perform predicted operation or operation, which is determined to be desirable, of at least one executable operation. In addition, the control unit 620 may collect history information including operation of the AI device 600 or user's feedback on the operation and store the history information in the memory unit 630 or the learning processor unit 640c or transmit the history information to the AI server (FIG. 1, 140). The collected history information may be used to update a learning model.

The memory unit 630 may store data supporting various functions of the AI device 600. For example, the memory unit 630 may store data obtained from the input unit 640a, data obtained from the communication unit 610, output data of the learning processor unit 640c, and data obtained from the sensing unit 640. In addition, the memory unit 630 may store control information and/or software code necessary to operate/execute the control unit 620.

The input unit 640a may acquire various types of data from the outside of the AI device 600. For example, the input unit 640a may acquire learning data for model learning, input data, to which the learning model will be applied, etc. The input unit 640a may include a camera, a microphone and/or a user input unit. The output unit 640b may generate video, audio or tactile output. The output unit 640b may include a display, a speaker and/or a haptic module. The sensing unit 640 may obtain at least one of internal information of the AI device 600, the surrounding environment information of the AI device 600 and user information using various sensors. The sensing unit 640 may include a proximity sensor, an illumination sensor, an acceleration sensor, a magnetic sensor, a gyro sensor, an inertia sensor, a red green blue (RGB) sensor, an infrared (IR) sensor, a finger scan sensor, an ultrasonic sensor, an optical sensor, a microphone and/or a radar.

The learning processor unit 640c may train a model composed of an artificial neural network using training data. The learning processor unit 640c may perform AI processing along with the learning processor unit of the AI server (FIG. 1, 140). The learning processor unit 640c may process information received from an external device through the communication unit 610 and/or information stored in the memory unit 630. In addition, the output value of the learning processor unit 640c may be transmitted to the external device through the communication unit 610 and/or stored in the memory unit 630.

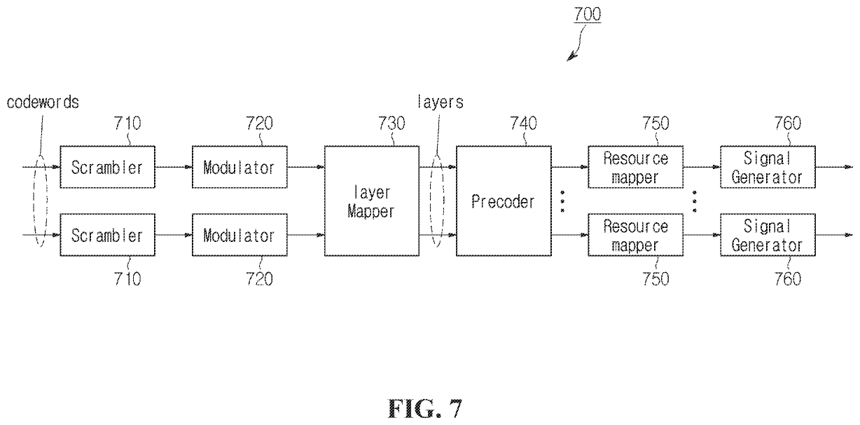

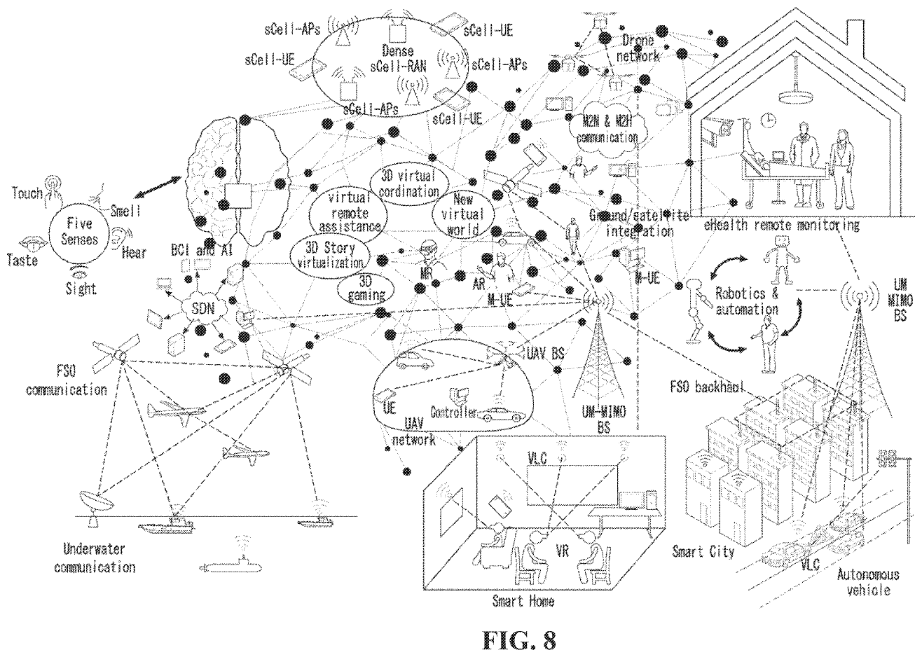

FIG. 7 illustrates a method of processing a transmitted signal applicable to the present disclosure. For example, the transmitted signal may be processed by a signal processing circuit. At this time, a signal processing circuit 700 may include a scrambler 710, a modulator 720, a layer mapper 730, a precoder 740, a resource mapper 750, and a signal generator 760. At this time, for example, the operation/function of FIG. 7 may be performed by the processors 202a and 202b and/or the transceiver 206a and 206b of FIG. 2. In addition, for example, the hardware element of FIG. 7 may be implemented in the processors 202a and 202b of FIG. 2 and/or the transceivers 206a and 206b of FIG. 2. For example, blocks 1010 to 1060 may be implemented in the processors 202a and 202b of FIG. 2. In addition, blocks 710 to 750 may be implemented in the processors 202a and 202b of FIG. 2 and a block 760 may be implemented in the transceivers 206a and 206b of FIG. 2, without being limited to the above-described embodiments.

A codeword may be converted into a radio signal through the signal processing circuit 700 of FIG. 7. Here, the codeword is a coded bit sequence of an information block. The information block may include a transport block (e.g., a UL-SCH transport block or a DL-SCH transport block). The radio signal may be transmitted through various physical channels (e.g., a PUSCH and a PDSCH). Specifically, the codeword may be converted into a bit sequence scrambled by the scrambler 710. The scramble sequence used for scramble is generated based in an initial value and the initial value may include ID information of a wireless device, etc. The scrambled bit sequence may be modulated into a modulated symbol sequence by the modulator 720. The modulation method may include pi/2-binary phase shift keying (pi/2-BPSK), m-phase shift keying (m-PSK), m-quadrature amplitude modulation (m-QAM), etc.

A complex modulation symbol sequence may be mapped to one or more transport layer by the layer mapper 730. Modulation symbols of each transport layer may be mapped to corresponding antenna port(s) by the precoder 740 (precoding). The output z of the precoder 740 may be obtained by multiplying the output y of the layer mapper 730 by an N*M precoding matrix W Here, N may be the number of antenna ports and M may be the number of transport layers. Here, the precoder 740 may perform precoding after transform precoding (e.g., discrete Fourier transform (DFT)) for complex modulation symbols. In addition, the precoder 740 may perform precoding without performing transform precoding.

The resource mapper 750 may map modulation symbols of each antenna port to time-frequency resources. The time-frequency resources may include a plurality of symbols (e.g., a CP-OFDMA symbol and a DFT-s-OFDMA symbol) in the time domain and include a plurality of subcarriers in the frequency domain. The signal generator 760 may generate a radio signal from the mapped modulation symbols, and the generated radio signal may be transmitted to another device through each antenna. To this end, the signal generator 760 may include an inverse fast Fourier transform (IFFT) module, a cyclic prefix (CP) insertor, a digital-to-analog converter (DAC), a frequency uplink converter, etc.

A signal processing procedure for a received signal in the wireless device may be configured as the inverse of the signal processing procedures 710 to 760 of FIG. 7. For example, the wireless device (e.g., 200a or 200b of FIG. 2) may receive a radio signal from the outside through an antenna port/transceiver. The received radio signal may be converted into a baseband signal through a signal restorer. To this end, the signal restorer may include a frequency downlink converter, an analog-to-digital converter (ADC), a CP remover, and a fast Fourier transform (FFT) module. Thereafter, the baseband signal may be restored to a codeword through a resource de-mapper process, a postcoding process, a demodulation process and a de-scrambling process. The codeword may be restored to an original information block through decoding. Accordingly, a signal processing circuit (not shown) for a received signal may include a signal restorer, a resource de-mapper, a postcoder, a demodulator, a de-scrambler and a decoder.

### 6G Communication System

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 1 below. That is, Table 1 shows the requirements of the 6G system.

TABLE 1

| Per device peak data rate | 1 Tbps |
|---|---|
| E2E latency | 1 ms |
| Maximum spectral efficiency | 100 bps/Hz |
| Mobility support | up to 1000 km/hr |
| Satellite integration | Fully |
| AI | Fully |
| Autonomous vehicle | Fully |
| XR | Fully |
| Haptic Communication | Fully |

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

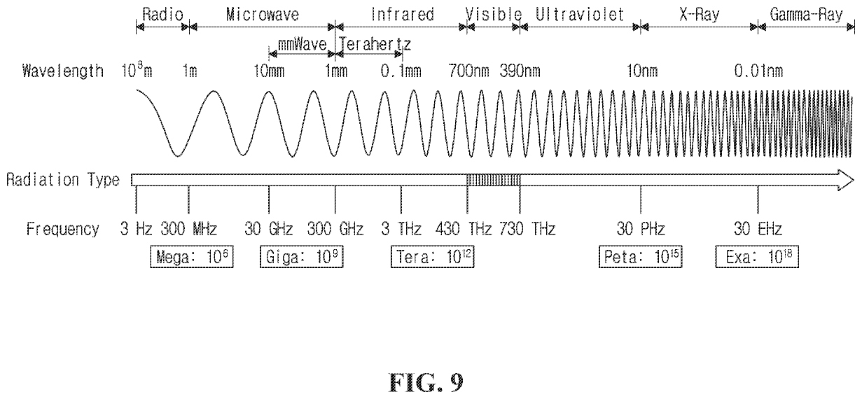

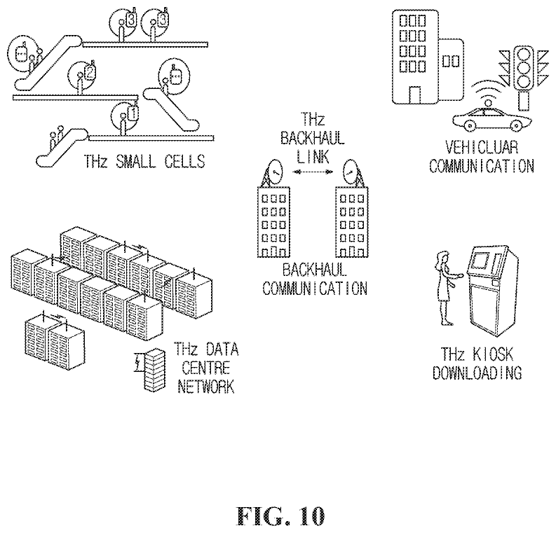

FIG. 10 illustrates an example of a communication structure providable in a 6G system applicable to the present disclosure.

Referring to FIG. 10, the 6G system will have 50 times higher simultaneous wireless communication connectivity than a 5G wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system.

### Core Implementation Technology of 6G System

### Artificial Intelligence (AI)

Technology which is most important in the 6G system and will be newly introduced is AI. AI was not involved in the 4G system. A 5G system will support partial or very limited AI. However, the 6G system will support AI for full automation. Advance in machine learning will create a more intelligent network for real-time communication in 6G. When AI is introduced to communication, real-time data transmission may be simplified and improved. AI may determine a method of performing complicated target tasks using countless analysis. That is, AI may increase efficiency and reduce processing delay.

Time-consuming tasks such as handover, network selection or resource scheduling may be immediately performed by using AI. AI may play an important role even in M2M, machine-to-human and human-to-machine communication. In addition, AI may be rapid communication in a brain computer interface (BCI). An AI based communication system may be supported by meta materials, intelligent structures, intelligent networks, intelligent devices, intelligent recognition radios, self-maintaining wireless networks and machine learning.

Recently, attempts have been made to integrate AI with a wireless communication system in the application layer or the network layer, but deep learning have been focused on the wireless resource management and allocation field. However, such studies are gradually developed to the MAC layer and the physical layer, and, particularly, attempts to combine deep learning in the physical layer with wireless transmission are emerging. AI-based physical layer transmission means applying a signal processing and communication mechanism based on an AI driver rather than a traditional communication framework in a fundamental signal processing and communication mechanism. For example, channel coding and decoding based on deep learning, signal estimation and detection based on deep learning, multiple input multiple output (MIMO) mechanisms based on deep learning, resource scheduling and allocation based on AI, etc. may be included.

Machine learning may be used for channel estimation and channel tracking and may be used for power allocation, interference cancellation, etc. in the physical layer of DL. In addition, machine learning may be used for antenna selection, power control, symbol detection, etc. in the MIMO system.

However, application of a deep neutral network (DNN) for transmission in the physical layer may have the following problems.

Deep learning-based AI algorithms require a lot of training data in order to optimize training parameters. However, due to limitations in acquiring data in a specific channel environment as training data, a lot of training data is used offline. Static training for training data in a specific channel environment may cause a contradiction between the diversity and dynamic characteristics of a radio channel.

In addition, currently, deep learning mainly targets real signals. However, the signals of the physical layer of wireless communication are complex signals. For matching of the characteristics of a wireless communication signal, studies on a neural network for detecting a complex domain signal are further required.

Hereinafter, machine learning will be described in greater detail.

Machine learning refers to a series of operations to train a machine in order to build a machine which can perform tasks which cannot be performed or are difficult to be performed by people. Machine learning requires data and learning models. In machine learning, data learning methods may be roughly divided into three methods, that is, supervised learning, unsupervised learning and reinforcement learning.

Neural network learning is to minimize output error. Neural network learning refers to a process of repeatedly inputting training data to a neural network, calculating the error of the output and target of the neural network for the training data, backpropagating the error of the neural network from the output layer of the neural network to an input layer in order to reduce the error and updating the weight of each node of the neural network.

Supervised learning may use training data labeled with a correct answer and the unsupervised learning may use training data which is not labeled with a correct answer. That is, for example, in case of supervised learning for data classification, training data may be labeled with a category. The labeled training data may be input to the neural network, and the output (category) of the neural network may be compared with the label of the training data, thereby calculating the error. The calculated error is backpropagated from the neural network backward (that is, from the output layer to the input layer), and the connection weight of each node of each layer of the neural network may be updated according to backpropagation. Change in updated connection weight of each node may be determined according to the learning rate. Calculation of the neural network for input data and backpropagation of the error may configure a learning cycle (epoch). The learning data is differently applicable according to the number of repetitions of the learning cycle of the neural network. For example, in the early phase of learning of the neural network, a high learning rate may be used to increase efficiency such that the neural network rapidly ensures a certain level of performance and, in the late phase of learning, a low learning rate may be used to increase accuracy.

The learning method may vary according to the feature of data. For example, for the purpose of accurately predicting data transmitted from a transmitter in a receiver in a communication system, learning may be performed using supervised learning rather than unsupervised learning or reinforcement learning.

The learning model corresponds to the human brain and may be regarded as the most basic linear model. However, a paradigm of machine learning using a neural network structure having high complexity, such as artificial neural networks, as a learning model is referred to as deep learning.

Neural network cores used as a learning method may roughly include a deep neural network (DNN) method, a convolutional deep neural network (CNN) method and a recurrent Boltzmman machine (RNN) method. Such a learning model is applicable.

### Terahertz (THz) Communication

THz communication is applicable to the 6G system. For example, a data rate may increase by increasing bandwidth. This may be performed by using sub-THz communication with wide bandwidth and applying advanced massive MIMO technology.

FIG. 9 illustrates an electromagnetic spectrum applicable to the present disclosure. For example, referring to FIG. 9, THz waves which are known as sub-millimeter radiation, generally indicates a frequency band between 0.1 THz and 10 THz with a corresponding wavelength in a range of 0.03 mm to 3 mm. A band range of 100 GHz to 300 GHz (sub THz band) is regarded as a main part of the THz band for cellular communication. When the sub-THz band is added to the mmWave band, the 6G cellular communication capacity increases. 300 GHz to 3 THz of the defined THz band is in a far infrared (IR) frequency band. A band of 300 GHz to 3 THz is a part of an optical band but is at the border of the optical band and is just behind an RF band. Accordingly, the band of 300 GHz to 3 THz has similarity with RE.

The main characteristics of THz communication include (i) bandwidth widely available to support a very high data rate and (ii) high path loss occurring at a high frequency (a high directional antenna is indispensable). A narrow beam width generated by the high directional antenna reduces interference. The small wavelength of a THz signal allows a larger number of antenna elements to be integrated with a device and BS operating in this band. Therefore, an advanced adaptive arrangement technology capable of overcoming a range limitation may be used.

### THz Wireless Communication

FIG. 10 illustrates a THz communication method applicable to the present disclosure.

Referring to FIG. 10, THz wireless communication uses a THz wave having a frequency of approximately 0.1 to 10 THz (1 THz=1012 Hz), and may mean terahertz (THz) band wireless communication using a very high carrier frequency of 100 GHz or more. The THz wave is located between radio frequency (RF)/millimeter (mm) and infrared bands, and (i) transmits non-metallic/non-polarizable materials better than visible/infrared rays and has a shorter wavelength than the RF/millimeter wave and thus high straightness and is capable of beam convergence.

### Artificial Intelligence System

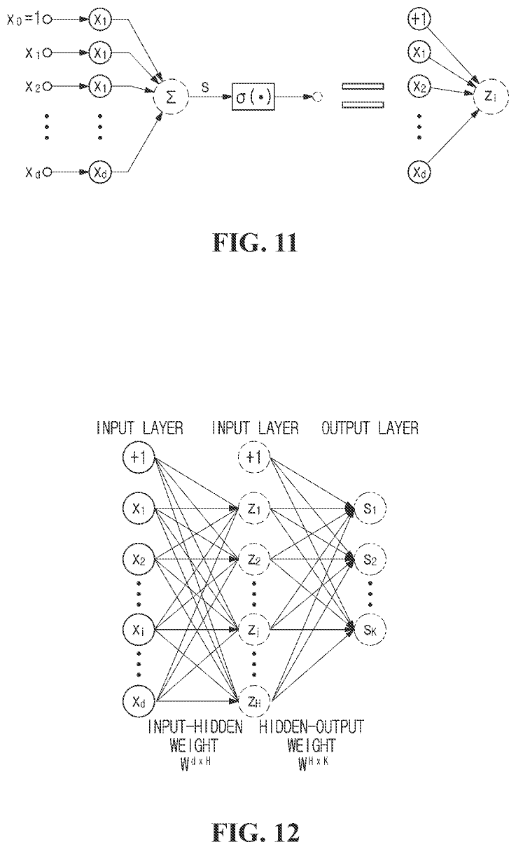

FIG. 11 illustrates a perceptron architecture in an artificial neural network applicable to the present disclosure. In addition, FIG. 12 illustrates an artificial neural network architecture applicable to the present disclosure.

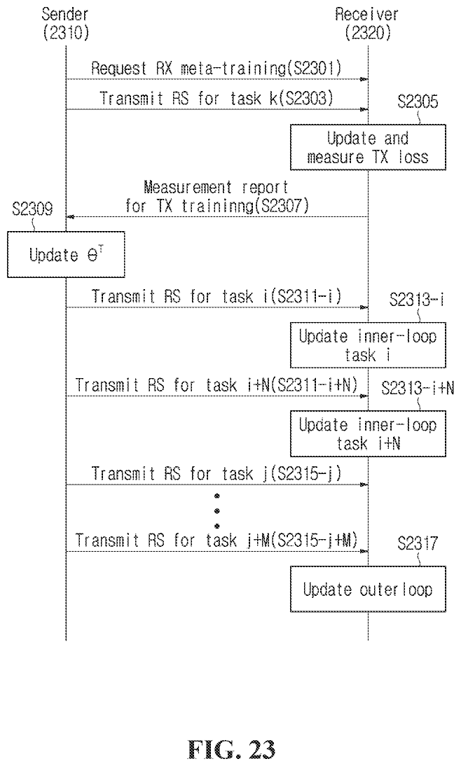

As described above, an artificial intelligence system may be applied to a 6G system. Herein, as an example, the artificial intelligence system may operate based on a learning model corresponding to the human brain, as described above. Herein, a paradigm of machine learning, which uses a neural network architecture with high complexity like artificial neural network, may be referred to as deep learning. In addition, neural network cores, which are used as a learning scheme, are mainly a deep neural network (DNN), a convolutional deep neural network (CNN), and a recurrent neural network (RNN). Herein, as an example referring to FIG. 23, an artificial neural network may consist of a plurality of perceptrons. Herein, when an input vector x={x₁, x₂, . . . , x_{d}} is input, each component is multiplied by a weight {W₁, W₂, . . . , W_{d}}, results are all added up, and then an activation function σ( ) is applied, of which the overall process may be referred to as a perceptron. For a large artificial neural network architecture, when expanding the simplified perceptron structure illustrated in FIG. 23, an input may be applied to different multidimensional perceptrons. For convenience of explanation, an input value or an output value will be referred to as a node.

Meanwhile, the perceptron structure illustrated in FIG. 11 may be described to consist of a total of 3 layers based on an input value and an output value. An artificial neural network, which has H (d+1)-dimensional perceptrons between a 1st layer and a 2nd layer and K (H+1)-dimensional perceptrons between the 2nd layer and a 3rd layer, may be expressed as in FIG. 12.

Herein, a layer, in which an input vector is located, is referred to as an input layer, a layer, in which a final output value is located, is referred to as an output layer, and all the layers between the input layer and the output layer are referred to as hidden layers. As an example, 3 layers are disclosed in FIG. 12, but since an input layer is excluding in counting the number of actual artificial neural network layers, it can be understood that the artificial neural network illustrated in FIG. 11 has a total of 2 layers. An artificial neural network is constructed by connecting perceptrons of a basic block two-dimensionally.

The above-described input layer, hidden layer and output layer are commonly applicable not only to multilayer perceptrons but also to various artificial neural network architectures like CNN and RNN, which will be described below. As there are more hidden layers, an artificial neural network becomes deeper, and a machine learning paradigm using a sufficiently deep artificial neural network as a learning model may be referred to as deep learning. In addition, an artificial neural network used for deep learning may be referred to as a deep neural network (DNN).

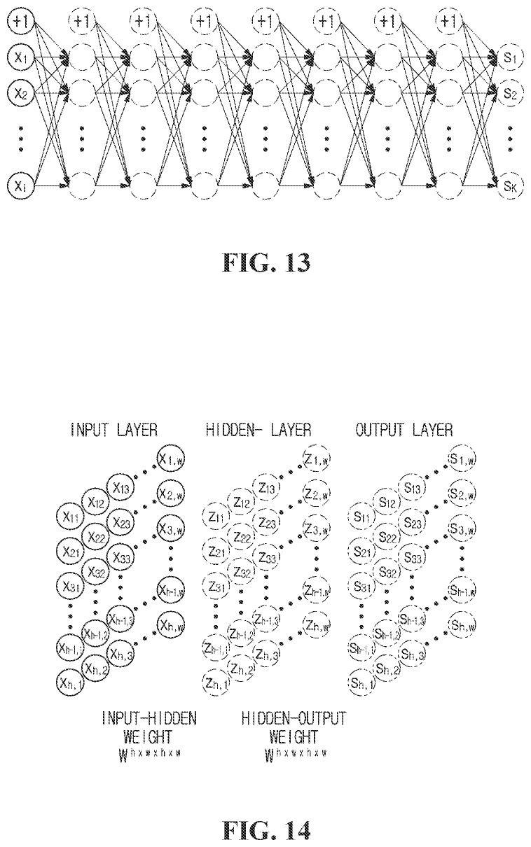

FIG. 13 illustrates a deep neural network applicable to the present disclosure.

Referring to FIG. 13, a deep neural network may be a multilayer perceptron consisting of 8 layers (hidden layers+output layer). Herein, the multilayer perceptron structure may be expressed as a fully-connected neural network. In a fully-connected neural network, there may be no connection between nodes in a same layer and only nodes located in neighboring layers may be connected with each other. A DNN has a fully-connected neural network structure combining a plurality of hidden layers and activation functions so that it may be effectively applied for identifying a correlation characteristic between an input and an output. Herein, the correlation characteristic may mean a joint probability between the input and the output.

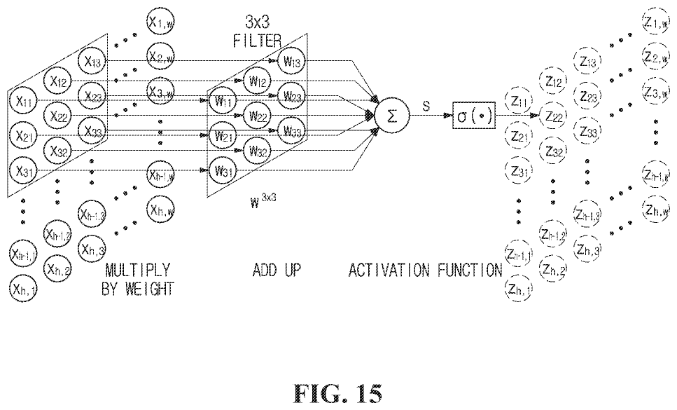

FIG. 14 illustrates a convolutional neural network applicable to the present disclosure. In addition, FIG. 15 illustrates a filter operation of a convolutional neural network applicable to the present disclosure.

As an example, depending on how to connect a plurality of perceptrons, it is possible to form various artificial neural network structures different from the above-described DNN. Herein, in the DNN, nodes located in a single layer are arranged in a one-dimensional vertical direction. However, referring to FIG. 14, it is possible to assume a two-dimensional array of w horizontal nodes and h vertical nodes (the convolutional neural network structures of FIG. 14). In this case, since a weight is applied to each connection in a process of connecting one input node to a hidden layer, a total of h×w weights should be considered. As there are h×w nodes in an input layer, a total of h²w² weights may be needed between two neighboring layers.

Furthermore, as the convolutional neural network of FIG. 14 has the problem of exponential increase in the number of weights according to the number of connections, the presence of a small filter may be assumed instead of considering every mode of connections between neighboring layers. As an example, as shown in FIG. 15, weighted summation and activation function operation may be enabled for a portion overlapped by a filter.

At this time, one filter has a weight corresponding to a number as large as its size, and learning of a weight may be performed to extract and output a specific feature on an image as a factor. In FIG. 15, a 3×3 filter may be applied to a top rightmost 3×3 area of an input layer, and an output value, which is a result of the weighted summation and activation function operation for a corresponding node, may be stored at z₂₂.

Herein, as the above-described filter scans the input layer while moving at a predetermined interval horizontally and vertically, a corresponding output value may be put a position of a current filter. Since a computation method is similar to a convolution computation for an image in the field of computer vision, such a structure of deep neural network may be referred to as a convolutional neural network (CNN), and a hidden layer created as a result of convolution computation may be referred to as a convolutional layer. In addition, a neural network with a plurality of convolutional layers may be referred to as a deep convolutional neural network (DCNN).

In addition, at a node in which a current filter is located in a convolutional layer, a weighted sum is calculated by including only a node in an area covered by the filter and thus the number of weights may be reduced. Accordingly, one filter may be so used as to focus on a feature of a local area. Thus, a CNN may be effectively applied to image data processing for which a physical distance in a two-dimensional area is a crucial criterion of determination. Meanwhile, a CNN may apply a plurality of filters immediately before a convolutional layer and create a plurality of output results through a convolution computation of each filter.

Meanwhile, depending on data properties, there may be data of which a sequence feature is important. A recurrent neural network structure may be a structure obtained by applying a scheme, in which elements in a data sequence are input one by one at each timestep by considering the distance variability and order of such sequence data sets and an output vector (hidden vector) output at a specific timestep is input with a very next element in the sequence, to an artificial neural network.

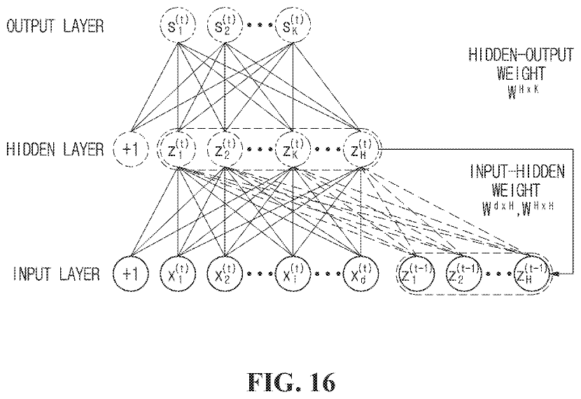

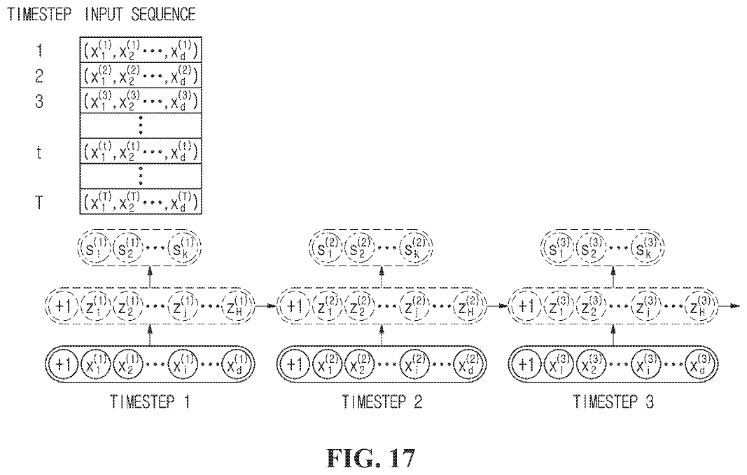

FIG. 16 illustrates a neural network architecture with a recurrent loop applicable to the present disclosure. FIG. 17 illustrates an operational structure of a recurrent neural network applicable to the present disclosure.

Referring to FIG. 16, a recurrent neural network (RNN) may have a structure which applies a weighted sum and an activation function by inputting hidden vectors {z₁^{(t-1)}, z₂^{(t-1)}, . . . , z_{H}^{(t-1)}} of an immediately previous timestep t-1 during a process of inputting elements {x₁^{(t)}, x₂^{(t)}, . . . , x_{d}^{(t)}} of a timestep t in a data sequence into a fully connected neural network. The reason why such hidden vectors are forwarded to a next timestep is because information in input vectors at previous timesteps is considered to have been accumulated in a hidden vector of a current timestep.

In addition, referring to FIG. 17, a recurrent neural network may operate in a predetermined timestep order for an input data sequence. Herein, as a hidden vector {z₁⁽¹⁾, z₂⁽¹⁾, . . . , z_{H}⁽¹⁾} at a time of inputting an input vector {x₁^{(t)}, x₂^{(t)}, . . . , x_{d}^{(t)}} of timestep 1 into a recurrent neural network is input together with an input vector {x₁⁽²⁾, x₂⁽²⁾, . . . , x_{d}⁽²⁾} of timestep 2, a vector {z₁⁽²⁾, z₂⁽²⁾, . . . , z_{H}⁽²⁾} of a hidden layer is determined through a weighted sum and an activation function. Such a process is iteratively performed at timestep 2, timestep 3 and until timestep T.

Meanwhile, when a plurality of hidden layers are allocated in a recurrent neural network, this is referred to as a deep recurrent neural network (DRNN). A recurrent neural network is so designed as to effectively apply to sequence data (e.g., natural language processing).

Apart from DNN, CNN and RNN, other neural network cores used as a learning scheme include various deep learning techniques like restricted Boltzmann machine (RBM), deep belief networks (DBN) and deep Q-Network, and these may be applied to such areas as computer vision, voice recognition, natural language processing, and voice/signal processing.

Recently, there are attempts to integrate AI with a wireless communication system, but these are concentrated in an application layer and a network layer and, especially in the case of deep learning, in a wireless resource management and allocation filed. Nevertheless, such a study gradually evolves to an MAC layer and a physical layer, and there are attempts to combine deep learning and wireless transmission especially in a physical layer. As for a fundamental signal processing and communication mechanism, AI-based physical layer transmission means application of a signal processing and communication mechanism based on an AI driver, instead of a traditional communication framework. For example, it may include deep learning-based channel coding and decoding, deep leaming-based signal estimation and detection, deep leaming-based MIMO mechanism, and AI-based resource scheduling and allocation.

### Specific Embodiments of the Present Disclosure

The present disclosure relates to meta online learning in a structure where a transmitter and a receiver are configured as a neural network to transfer an end-to-end message. A neural network-based wireless communication system uses a feature that a neural network is good at approximating an arbitrary function. In case a message is transmitted from a TX neural network, passes through a radio channel and then is received by a RX neural network, good transmission/reception performance may be obtained at a channel with non-linearity by using the feature of good approximation of an arbitrary function. However, neural network learning is indispensable for obtaining good performance.

General learning is performed using a lot of data. However, due to rapid changes in channel, meta learning, which learns a neural network using a relatively small amount of data, is required. When applying online meta learning that constantly performs learning in a situation where a channel changes, a receiver may easily measure a loss function through outputs of a reference signal and reference data, and meta learning for the receiver may be performed. However, because a TX channel may also change rapidly, there still remains a problem of minimizing feedback data cost between a transmitter and the receiver, which occurs by applying meta learning to both the transmitter and the receiver.

The present disclosure relates to a meta learning area to which meta learning is applied through regional division in order to cope with long-tailed propagation environment distribution of sub-6 GHz communication, mmWave, and THz communication. In a meta learning area, the present disclosure describes various embodiments for meta-learning a reference signal (RS) used in each band and effectively performing a task present according to each reference signal.

Meta learning is a learning technique of enabling inference for anew task such as regression and classification to be well performed by using a neural network that is pretrained for many task. That is, meta learning may be understood as learn-to-learn that enables learning and inference to be well performed for a new task.

In meta learning, a weight of a model of a neural network, which is pretrained through tasks, is referred to as a meta model parameter θ, and learning of the meta model parameter is defined as meta-training. When a new task occurs, the meta model parameter θ is re-learned as a model parameter φ adapted to the new task, and performing inference based on the adapted model parameter φ is referred to as adaptation. In the present disclosure, a model parameter for a task may be called a task model parameter so as to be distinguished from a meta model parameter.

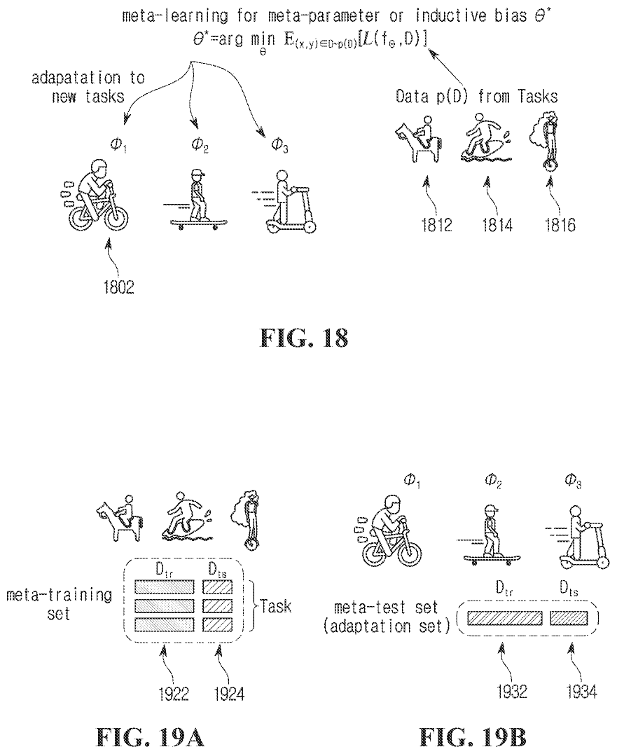

Meta learning may be described by a more intuitive example in FIG. 18. FIG. 18 illustrates a concept of meta learning applicable to the present disclosure. Referring to FIG. 18, an agent wants to process a new task called ‘riding a bicycle’ 1802. In case the agent has already performed meta-training for ‘riding something’ by existing tasks, the agent may easily succeed in riding the bicycle. In case the meta model parameter θ is learned for tasks such as horseback riding 1812, surfing 1814, and riding an electric unicycle 1816, adaptation to anew task of riding a bicycle may be easily performed.

As for mathematical modeling, a device may collect data from task distribution p (D), learn the meta model parameter θ based on a neural network model f, and then determine the model parameter φ required for a new task, thereby performing adaptation. Each task may be defined as shown in Formula 1.

T={L(θ,D),ρ(x₁),ρ(xₜ₊₁|xₜ,yₜ),H} [Formula 1]

In Formula 1, T means a task, LO means a loss function, θ means a meta model parameter, D is a relevant data set, ρ(x₁) means an initial probability of task data, ρ(xₜ₊₁|xₜ,yₜ) means a conditional transition probability of task data, Hand means a time length of a corresponding task. A target function for learning the meta model parameter θ in meta-training and a data set in task distribution may be defined as shown in Formula 2.

$${0}^{*} = \begin{matrix}arg min \\ θ\end{matrix} {E}_{( x , y ) ∈ D - p ( D )} [ L ( {f}_{θ} , {D}_{metatrain} ) ] = \begin{matrix}arg min \\ θ\end{matrix} p ( θ \vert {D}_{metatrain} ) \qquad [ Formula 2 ]$$

In Formula 2, θ* means an optimal meta model parameter, E[ ] means an average operator, D means a relevant data set, x,y mean data samples, p(D) means data distribution, LO means a loss function, f_{θ} means a meta learning function, Dₘₑₜₐₜᵣₐᵢₙ means a data set selected for meta-training, θ and means a meta model parameter.

FIG. 19A and FIG. 19B illustrate examples of data sets for meta learning applicable to the present disclosure. Referring to FIG. 19A and FIG. 19B, in meta-training, a data set (e.g. a meta-training set, a meta-test test) includes data sets of a plurality of tasks different from each other. In addition, in a single task, a data set may include a training set 1922 (e.g. Dₜᵣ) and a test set 1924 (e.g. Dₜₛ). When multiple pieces of such individual task data gather, a meta-training set may be determined. For example, a transmitter and a receiver may determine task model parameters for each task through an inner loop by using the training set 1922 and determine a meta model parameter through an outer loop by using the test set 1924.

Adaptation for a new specific task maximizes a conditional probability value, which best describes meta test data for the specific task, based on an optimal meta model parameter θ*. A meta test data set is also divided into a training set 1932 and a test set 1934. Herein, a training set is mainly consumed to learn a task model parameter

$${θ}^{*} = {arg min}_{θ} {E}_{( x , y ) ∈ D - p ( D )} [ L ( {f}_{θ} , {D}_{metatrain} ) ] = {arg min}_{θ} p ( θ \vert {D}_{metatrain} ) \qquad [ Formula 2 ]$$

for a new task from a meta model parameter θ*. A test set is used for actually performing a task.

Meta learning algorithms for obtaining an optimal meta model parameter θ* may be classified into three main types. A model (e.g. black box)-based method, an optimization-based method, and a non-parametric method have been proposed. These three methods have the following common characteristics. First, the methods generalize data obtained from distribution of many tasks. Second, the methods sample one task from a meta task data set and perform learning repeatedly by using relevant task data Dₜᵣ and Dₜₛ.

Meta learning algorithms and inner and outer loops are as follows.

The model-based method determines θ* by using another model or neural network φₜ that describes a sampled specific task i well. The optimization-based method does not have any separate model that best describes a task i, but determines θ* by using gradient information of a current model. The non-parametric method considers a model that well describes a feature of φ_{z} of a task i.

Meta learning shows good performance when a data set has a long-tailed distribution. In the case of a data set with a long-tailed distribution, in terms of classification, there are a lot of classes, and a data size in each class is very small. Meta learning shows good performance also in a small data set. A most useful application example is few-shot learning. Even when a few images are shown, excellent performance is achieved in identifying the images after meta learning is performed.

Meta learning algorithms may be classified into model-based approach, optimization-based approach, and non-parametric approach. Each of the algorithms may be described as follows.

TABLE 2

| Algorithms | Contents |
|---|---|
| Model-based approach | 1. Sample Task i |
| | 2. Sample data set Dⁱtr, Dⁱts |
| | 3. Compute ^{Φ} [symbol] ←f_{θ}(Dⁱtr) |
| | 4. update θ using ∇_{θ}L(^{Φ} [symbol] , Dⁱts) |
| | 5. return to 1. |
| Optimization-based | 1. Sample Task i |
| approach | 2. Sample data set Dⁱtr, Dⁱts |
| | 3. Optimize ^{Φ} [symbol] ←∇_{θ}L(θ, Dⁱtr) |
| | 4. update θ using ∇_{θ}L(^{Φ} [symbol] , Dⁱts) |
| | 5. return to 1. |
| Non-parametric approach | 1. Sample Task i |
| | 2. Sample data set Dⁱtr, Dⁱts |
| | 3. Compute |
| | 4. update θ using ∇_{θ}L(^{y} [symbol] , ^{y} [symbol] ) |
| | 5. return to 1. |

[symbol]

indicates data missing or illegible when filed

A common characteristic of the algorithms of meta learning is that the algorithms consist of an inner loop, which determines φ_{z} by repeating many individual tasks i at operation #3, and an outer loop that covers operation #4 and operation #1 based on the inner loop and determines θ* by using φ_{z}. θ* means a parameter that best generalizes distribution of tasks. Thus, meta learning may be understood as hierarchical parameter learning of two levels.

Meta learning tasks according to various embodiment of the present disclosure may be related to a reference signal. That is, the present disclosure relates to meta learning of a transmit/receive task related to a reference signal in communication. A reference signal and a meta learning task may be described as follows. A reference signal is a signal having a value that is agreed beforehand between a transmitter and a receiver. Various types of reference signals may be defined. A transmitter may transmit a phase-tracking reference signal (PTRS) with a specific pattern in order to correct a phase error in a high-frequency band. A transmitter may transmit a demodulation RS (DMRS) with a specific pattern to estimate a channel and to correct data. In addition, a transmitter may transmit CSI-RSs with specific patterns respectively to track temporal synchronization of a channel, to track a beam, and to find out channel quality information of RI/PMI/CQI. In addition, a transmitter may transmit a sounding reference signal (SRS) with a specific pattern for channel sounding. In addition, a base station may transmit a positioning reference signal (PRS) for measuring a position of a UE. In the present disclosure, apart from those mentioned above, a reference signal may also be understood as any signal that is allocated to a radio resource area for meta learning. Information for transmitting and receiving a reference signal may be known to a transmitter and a receiver in advance or be configured through signaling (e.g. PHY, MAC CE, RRC).

A task for a reference signal or data consists of a data set and a loss function. A data set may be obtained by succeeding in reception and measurement required by each reference signal. For example, in the case of a beam CSI-RS, beam measurement is performed, and when reception is successful with respect to a beam identifier, a supervised learning data set may be secured. In the case of a DMRS, when data reception is successful and thus CRS is correctly obtained, a supervised learning data set may be secured. According to meta learning, a data set may be divided into a meta-training set and a meta test set. A loss function of each task may be configured as cross entropy of received data or measured data.

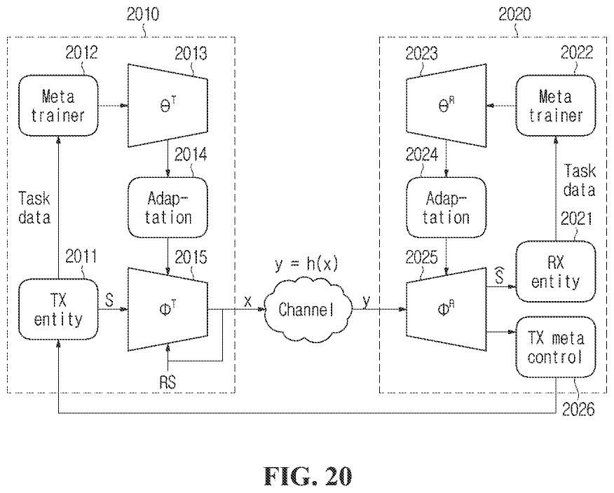

FIG. 20 illustrates functional structures of devices for supporting meta learning according to an embodiment of the present disclosure. FIG. 20 exemplifies a transmit/receive model where two devices 2010 and 2020 perform communication according to an embodiment and the first device 2010 functions as a transmitter and the second device 2020 functions as a receiver. In case of downlink communication, the first device 2010 may be understood as a base station, and the second device 2020 may be understood as a UE. In case of uplink communication, the first device 2010 may be understood as a UE, and the second device 2020 may be understood as a base station.

Referring to FIG. 20, the first device 2010 includes a transmit entity 2011, a meta trainer 2012, a meta transmitter 2013, an adaptation block 2014, and a task transmitter 2015. The transmit entity 2011 performs overall control and processing for data transmission. For example, the transmit entity 2011 may generate TX data and provide necessary information for operations of other blocks. Specifically, the transmit entity 2011 may provide task data to the meta trainer 2012 and provide a message S to the meta transmitter 2015. Herein, the transmit entity 2011 may control a meta learning operation by using a measurement report received from the second device 2020. The meta trainer 2012 determines a metal model parameter by performing meta learning, and the meta transmitter 2013 holds the meta model parameter that is determined through meta learning. The adaptation block 2014 determines a task model parameter for a given task by performing adaptation for a meta model parameter, and the task transmitter 2015 processes the message and at least one reference signal according to the task by using the adapted task model parameter that is determined through the adaptation.

Referring to FIG. 20, the second device 2020 includes a receive entity 2021, a meta trainer 2022, a meta receiver 2023, an adaptation block 2024, a task receiver 2025, and a transmit meta control block 2026. The receive entity 2021 performs overall control and processing for data reception. For example, the receive entity 2021 may process a received message and provide necessary information for operations of other blocks. Specifically, the receive entity 2021 may provide task data to the meta trainer 2022 and provide a message S to the meta receiver 2025. The meta trainer 2022 determines a meta model parameter by performing meta learning, and the meta receiver 2023 holds the meta model parameter that is determined through meta learning. The adaptation block 2024 determines a task model parameter for a given task by performing adaptation for the meta model parameter, and the task receiver 2025 restores the message by processing the message and at least one reference signal according to the task by using the adapted task model parameter, which is determined through the adaptation, and provide the restored message to the receive entity 2021. The transmit meta control block 2026 generates information for learning of neural networks of the first device 2010 and transmits a measurement report including the generated information to the first device 2010.

Referring to FIG. 20, a meta neural network may consist of one or a plurality of meta transmitters 2013 and one or a plurality of meta receivers 2023. The meta neural network includes generalized parameter values θ ^{T} and θ^{R} that are obtained through meta-training for a plurality of tasks. Task neural networks may consist of one or a plurality of task transmitters 2015 and one or a plurality of task receivers 2025. The task neural networks may have different parameters according to each reference signal task. When transmitting an actual message S, a task neural network may be transformed to a transmit and receive task neural network suitable for a corresponding channel situation, which is derived through adaptation from the meta neural network, and transmit and receive the message S. Finally, the second device 2020 restores a message Ŝ. The transmit entity 2011 and the receive entity 2021 mean objects that transmit and receive data. The meta trainer 2012 and the meta trainer 2022 learn the meta parameters θ^{T} and θ^{R} by using information of a transmit task neural network φ^{T} and a receive task neural network φ^{R}. The transmit meta control block 2026 is a controller of the second device 2020 for training a transmitter neural network. The transmit meta control block 2026 measures loss for training the transmit neural network and gives feedback on the loss to the first device 2010 through a measurement report. A feedback operation is performed through the measurement report. During a meta-training process, because the measurement report requires a bandwidth, the measurement report is considered as indirect cost, that is, overhead. The transmit meta control block 2026 may serve to minimize such cost.

A transmitter and a receiver, which perform online meta learning, run two processes simultaneously. The first process is an online meta-training process. The online meta-training process is to search for a meta model parameter θ* with best performance at a current time. The online meta-training process determines a task parameter φ for the transmitter and the receiver that are trained from a plurality of tasks through an inner loop. In addition, the online meta-training process determines a meta model parameter θ* that well generalizes task parameters through an outer loop. The second process is to keep performing adaptation based on learning data obtained from a recently used task through a recent meta parameter θ* and to perform transmission/reception with φ.

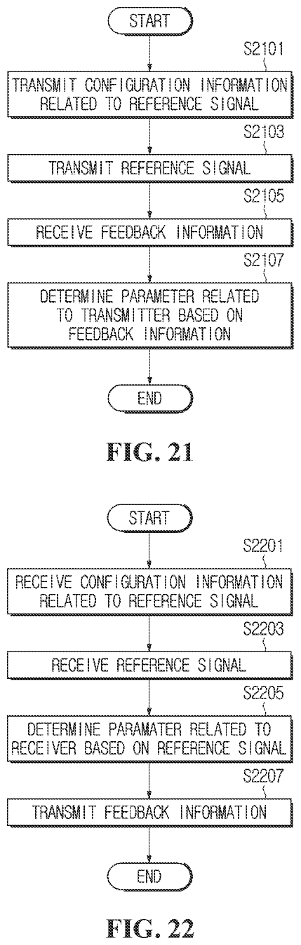

*212 FIG. 21 illustrates a procedure of determining a parameter related to a transmitter according to an embodiment of the present disclosure. FIG. 21 exemplifies an operating method of a device (e.g. a base station or a UE) for transmitting a reference signal for a task related to the reference signal.

Referring to FIG. 21, at step S2101, the device transmits configuration information related to a reference signal. The configuration information may include at least one of information related to reference signals that are transmitted for channel measurement (e.g. a resource, a sequence, etc.), information related to a required operation (e.g. measurement, learning, training, etc.), and information related to feedback (e.g. a format, a resource, a number of times of feedback, an interval, etc.). In addition, according to various embodiments, the configuration information may include information related to meta learning. For example, the information related to meta learning may indicate at least one of tasks used for meta learning, a batch size for training, an optimizing method of a model parameter, at least one task used for an inner loop, and at least one task used for an outer loop, and include at least one configuration value related to an indicated item. According to an embodiment, the configuration information may function as a message for requesting to perform meta training of the device or another device.

At step S2103, the device transmits reference signals. The device transmits the reference signals based on the configuration information. That is, the device may transmit reference signals based on a sequence indicated by the configuration information through a resource indicated by the configuration information. Herein, according to various embodiments, the device may transmit reference signals for at least one task related to meta learning. The reference signals related to meta learning may include a plurality of reference signal sets, and types of the reference signals may be different from each other according to the reference signal sets. In this case, the plurality of reference signal sets may be transmitted in stages.

At step S2105, the device receives feedback information. That is, the device receives the feedback information that is generated based on the transmitted reference signals. For example, the feedback information may include measurement information according to a type of a reference signal. According to various embodiments, the feedback information may include loss information for meta learning. Herein, the loss information is information related to an error between a result, which is inferred from a reference signal passing through a channel by using a receiver neural network in a counterpart device, and a label, and may be determined based on a loss function. Herein, the loss information in the feedback information may include a loss value for a transmitter neural network used in the device. That is, the loss information may indicate a value that is determined based on an error between input data into the receiver neural network and an output value of the receiver neural network.

At step S2107, the device configures at least one parameter related to the transmitter based on the feedback information. That is, the device may configure at least one parameter related to computation for processing a bit string, information, data, a message, or a signal, which is transmitted based on the feedback information. According to various embodiments, the device may perform learning for the transmitter neural network based on the feedback information. Specifically, the device may perform meta learning for determining a meta model parameter. Herein, a configuration may include at least one of determining a value of at least one non-existing parameter or updating a value of at least one existing parameter.

As described with reference to FIG. 21, a device may transmit a reference signal, receive feedback information corresponding to the reference signal, and configure at least one parameter related to a transmitter based on the feedback information. A series of operations, including the above-described transmitting of a reference signal, receiving of feedback information, and configuring of at least one parameter, may be repeatedly performed two or more times. According to an embodiment, a first repetition may be performed for learning for a neural network of a specific task, a second repetition may be performed for an inner loop for determining task model parameters in meta learning, and a first repetition may be performed for an outer loop for determining a meta model parameter in meta learning. Herein, according to an embodiment, during the second repetition, a device may receive only loss information for at least one task among tasks corresponding to transmitted reference signals. In addition, according to an embodiment, during the third repetition, the device may transmit reference signals for at least one task corresponding to the received loss information.

FIG. 22 illustrates a procedure of determining a parameter related to a receiver according to an embodiment of the present disclosure. FIG. 22 exemplifies an operating method of a device (e.g. a base station or a UE) that receives a reference signal for a task related to the reference signal.

Referring to FIG. 22, at step S2201, the device receives configuration information related to a reference signal. The configuration information may include at least one of information related to reference signals that are transmitted for channel measurement (e.g. a resource, a sequence, etc.), information related to a required operation (e.g. measurement, learning, training, etc.), and information related to feedback (e.g. a format, a resource, a number of times of feedback, an interval, etc.). In addition, according to various embodiments, the configuration information may include information related to meta learning. For example, the information related to meta learning may indicate at least one of tasks used for meta learning, a batch size for training, an optimizing method of a model parameter, at least one task used for an inner loop, and at least one task used for an outer loop, and include at least one configuration value related to an indicated item. According to an embodiment, the configuration information may function as a message for requesting to perform meta training of the device or another device.

At step S2203, the device receives reference signals. The device receives the reference signals based on the configuration information. That is, the device may receive reference signals based on a sequence indicated by the configuration information through a resource indicated by the configuration information. Herein, according to various embodiments, the device may transmit reference signals for at least one task related to meta learning. The reference signals related to meta learning may include a plurality of reference signal sets, and types of the reference signals may be different from each other according to the reference signal sets. In this case, the plurality of reference signal sets may be transmitted in stages

At step S2205, the device configures at least one parameter related to a receiver based on the reference signals. That is, the device may configure at least one parameter related to computation for processing a bit string, information, data, a message, or a signal, which is received from a counterpart device. According to various embodiments, the device may perform learning for a receiver neural network based on the feedback information. For example, the device may update parameters (e.g. weights) of the receiver neural network through backpropagation. Specifically, the device may perform meta learning for determining a metal model parameter. Herein, a configuration may include at least one of determining a value of at least one non-existing parameter or updating a value of at least one existing parameter.

At step S2207, the device transmits feedback information. That is, the device transmits the feedback information that is generated based on transmitted reference signals. For example, the feedback information may include measurement information according to a type of a reference signal. According to various embodiments, the feedback information may include loss information for meta learning of a counterpart device. Herein, the loss information is information related to an error between a result, which is inferred from a reference signal passing through a channel by using a receiver neural network, and a label, and may be determined based on a loss function. Herein, the loss information in the feedback information may include a loss value for a transmitter neural network used in the counterpart device. That is, the loss information may indicate a value that is determined based on an error between input data into the receiver neural network and an output value of the receiver neural network. For example, the loss information may be related to a result of backpropagation in the receiver neural network, which is performed up to an input layer of the reiver neural network.

As described with reference to FIG. 22, a device may a device may receive a reference signal, configure at least one parameter related to a receiver based on the feedback information, and transmit feedback information corresponding to the reference signal. A series of operations, including the above-described receiving of a reference signal, configuring of at least one parameter, and transmitting of feedback information, may be repeatedly performed two or more times. According to an embodiment, a first repetition may be performed for learning for a neural network of a specific task, a second repetition may be performed for an inner loop for determining task model parameters in meta learning, and a third repetition may be performed for an outer loop for determining a meta model parameter in meta learning. Herein, according to an embodiment, during the second repetition, a device may transmit only loss information for at least one task among tasks corresponding to received reference signals. In addition, according to an embodiment, during the third repetition, the device may receive reference signals for at least one task corresponding to the transmitted loss information.

Hereinafter, the present disclosure will describe detailed embodiments for online meta-training. In the description below, two objects, which perform meta-training, are described as a transmitter and a receiver. According to various situations, the transmitter and the receiver may be understood as a base station and a UE, a UE and a base station, and a UE and a UE. In the description below, transmitting a task may include transmitting at least one reference signal for the task.

Optimization of an object function of a transmitter in online meta-training is performed based on evaluation of

$${min}_{{θ}^{T} , {ϕ}^{R}} L ( {θ}^{T} , {ϕ}^{R} ) .$$

Optimization of an object function of a receiver in online meta-training is performed based on evaluation of

$${min}_{{θ}^{T} , {ϕ}^{R}} L ( {θ}^{T} , {ϕ}^{R} ) .$$

Evaluation for optimizing an objective function of a transmitter and evaluation for optimizing an objective function of a receiver are iteratively performed by turns.

Meta-training of a receiver may be performed as follows. FIG. 23 illustrates an example of a procedure for performing meta learning for a receiver according to an embodiment of the present disclosure. FIG. 23 exemplifies signaling between a transmitter 2310 and a receiver 2320.

Referring to FIG. 23, at step 2301, the transmitter 2310 transmits a RX meta-training request message to the receiver 2320. The RX meta-training request message includes information on a set of RS tasks used during meta-training. In addition, the RX meta-training request message includes at least one of a batch size for gradient-based training, an optimizing method, and a configuration value associated therewith. In addition, the RX meta-training request message includes information on a task set for each inner loop and a task set used in an outer loop. Next, at step S2303, the transmitter 2310 transmits at least one reference signal for a task k. When the transmitter 2310 transmits at least one reference signal for the task k, at step S2305, the receiver 2320 updates a parameter of a RX neural network. The parameter of the RX neural network may be updated as shown in Formula 3 below.

φ^{R}=u(φ^{R},∇_{φ}_{^{R}}L(θ^{T},φ^{R})) [Formula 3]

In Formula 3, φ^{R} means a task model parameter of a receiver, u means an update function, LO means a loss function, and θ^{T} means a meta model parameter of a transmitter. Here, the update function u may be different according to an optimizing method.

Next, at step S2307, the receiver 2320 reports loss through a measurement report. In other words, the receiver 2320 determines loss for the transmitter 2310 and transmits a measurement report including information on the loss to the transmitter 2310. Next, at step S2309, the transmitter 2310 updates a TX neural network. Training for the task k, which is performed at the above-described steps S2303 to S2309, that is, initial training of meta learning may be performed to give a preliminary learning opportunity so that neural networks of the transmitter and the receiver may be in their best state. Thus, parameters of the neural networks may be prevented from learning past channels excessively. However, according to another embodiment, the above-described steps S2303 to S2309 may be omitted.

Next, at steps S2311-i to S2311-i+N, reference signals for N inner loops are transmitted from a task i. When the reference signals start being transmitted, at steps S2313-i to S2313-i+N, a task model parameter φ^{R} of each task is updated by an inner loop. The task model parameter may be updated as shown in Formula 4.

φ^{R}=fᵢₙₙₑᵣ(θ^{R},∇_{θ}_{^{k}}L(φ^{T},θ^{R})) [Formula 4]

In Formula 4, φ^{R} means a task model parameter of a receiver, fᵢₙₙₑᵣ means a meta learning function used in an inner loop, θ^{R} means a meta model parameter of the receiver, and LO means a loss function. Here, fᵢₙₙₑᵣ may be different according to a meta learning approach.

Next, at steps S2315-j to S2315-j+M, the transmitter 2310 transmits reference signals for tasks j to j+M. At step S2323, the receiver 2320 samples at least one task among transmitted tasks and updates a meta model parameter θ^{R} in an outer loop based on the task model parameter φ^{R} that is updated in the inner loop. The meta model parameter may be updated as shown in Formula 5 below.

θ^{R}=fₒᵤₜₑᵣ(θ^{R},∇_{θ}_{^{R}}L(φ^{T},φ^{R})) [Formula 5]

In Formula 5, θ^{R} means a meta model parameter of a receiver, fₒᵤₜₑᵣ means a meta learning function used in an outer loop, LO means a loss function, and φ^{T} means a task model parameter of a transmitter for a specific task. Here, fₒᵤₜₑᵣ is different according to a meta learning approach.

The key of meta-training in a transmitter is to minimize a feedback resource by transmitting, by a receiver, only some of task parameters

$${ϕ}_{i}^{T} , {ϕ}_{i + 1}^{T} , … {ϕ}_{i + N}^{T} ,$$

which best describe the meta model parameter θ^{T}, to the transmitter. In the description below, transmitting a task means transmitting at least one reference signal for the task.

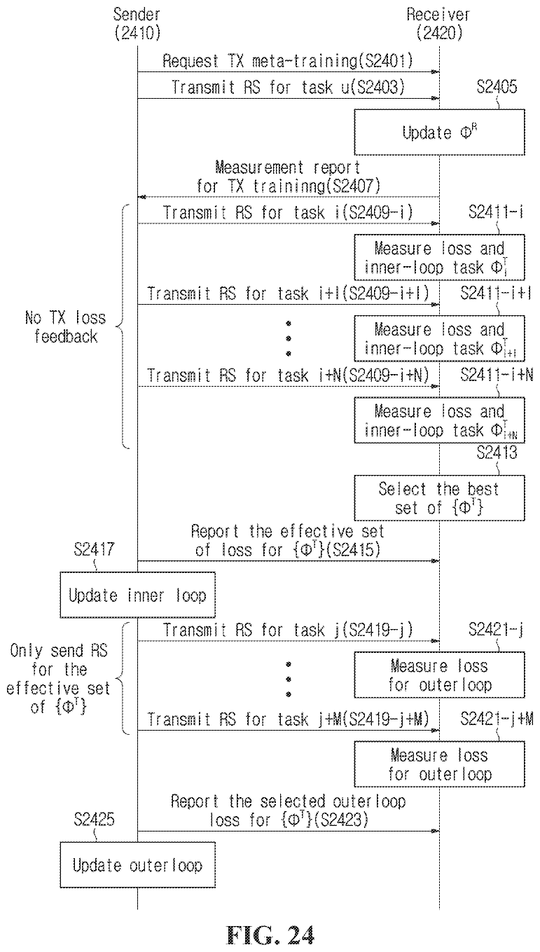

Meta-training of a transmitter may be performed as follows. FIG. 24 illustrates an example of a procedure for performing meta learning for a transmitter according to an embodiment of the present disclosure. FIG. 24 exemplifies signaling between a transmitter 2410 and a receiver 2420.

Referring to FIG. 24, at step S2401, the transmitter 2410 transmits a TX meta-training request message to the receiver 2420. The TX meta-training request message includes information on a set of RS tasks used during meta-training. In addition, the TX meta-training request message includes at least one of a batch size for gradient-based training, an optimizing method, and a configuration value associated therewith.

At step S2403, the transmitter 2410 transmits at least one reference signal for a task u. The task u is to transmit a reference signal for training a RX parameter to be used in TX meta-training. At step S2405, the receiver 2420 may update a task model parameter φ^{R} for the task u, and at step S2407, the receiver 2420 may give feedback on loss for the task u to the transmitter 2410. Then, a TX meta-training duration begins.

At steps S2409-i to S2409-i+N, N tasks are transmitted. At steps S2411-i to S2411-i+N, loss required for training an inner loop is measured in the receiver 2420. Herein, in the inner loop, a RX controller of the receiver 2420 and a sending unit perform the following operations. The receiver 2420 prepares a same model as a TX neural network. Information on the same model is transferred by a meta-learning ID in a TX meta-training request message, and thus the receiver 2420 may obtain the same model. A meta-learning model is assumed to be agreed in advance.

At steps S2409-i to S2409-i+N, the transmitter 2410 transmits reference signals for a inner-loop task such as RSᵢ to RS_{i+N}. At steps S2411-i to S2411-i+N, the receiver 2420 calculates each loss by using a RX signal and a copy of the TX neural network and determines task model parameters

$$\{ {ϕ}_{i}^{T} , {ϕ}_{i + 1}^{T} , … {ϕ}_{i + N}^{T} \} ,$$

of the transmitter 2410. Herein, the task model parameters may be determined as shown in Formula 6 below.

φ^{T}=fᵢₙₙₑᵣ(θ^{T},∇_{θ}_{^{r}}L(θ^{T},φ^{R})) [Formula 6]

In Formula 6, φ^{T} means a task model parameter of a transmitter, fᵢₙₙₑᵣ means a meta learning function used in an inner loop, θ^{T} means a meta model parameter of the transmitter, LO means a loss function, and φ^{R} means a task model parameter of a receiver. Here, fᵢₙₙₑᵣ may be different according to a meta learning approach. Herein, the meta model parameter may be understood as a parameter that is determined previous meta learning.

At step S2413, the receiver 2420 selects a most valid subset

$$\{ {ϕ}_{j}^{T} , {ϕ}_{j + 1}^{T} , … {ϕ}_{j + M}^{T} \}$$

for calculating θ^{T} among inner-loop parameters

$$\{ {ϕ}_{i}^{T} , {ϕ}_{i + 1}^{T} , … {ϕ}_{i + N}^{T} \} ,$$

and at step S2415, the receiver 2420 gives feedback on the loss to the transmitter 2410. Here, M<N.

At step S2417, a TX end prepares a task neural network through the loss of the parameters

$$\{ {ϕ}_{j}^{T} , {ϕ}_{j + 1}^{T} , … {ϕ}_{j + M}^{T} \} ,$$

on which the feedback is given, and generates

$$\{ {ϕ}_{j}^{T} , {ϕ}_{j + 1}^{T} , … {ϕ}_{j + M}^{T} \} .$$

At steps S2419-j to S2419-j+M, the transmitter 2410 transmits tasks j to j+M related to a reference signal through the generated parameters

$$\{ {ϕ}_{j}^{T} , {ϕ}_{j + 1}^{T} , … {ϕ}_{j + M}^{T} \} ,$$

and at steps S2421-j to S2421-jM, the receiver 2420 measures loss for an inner loop. At step S2423, the receiver 2420 performs outer-loop meta-training by giving feedback on the loss to the transmitter 2410. In other words, at step S2425, the transmitter 2410 may perform the outer-loop meta-training based on the loss, on which the feedback is given from the receiver 2420. A meta parameter of the transmitter 2410 may be updates as shown in Formula 7.

θ^{T}=fₒᵤₜₑᵣ(θ^{T},∇_{θ}_{^{r}}L(φ^{T},φ^{R}) [Formula 7]

In Formula 7, a means a meta model parameter of a transmitter, fₒᵤₜₑᵣ means a meta learning function used in an outer loop, 10 means a loss function, * means a task model parameter of the transmitter, and φ^{R} means a task model parameter of a receiver.

The above-mentioned meta learning methodologies are classified into the model-based method, the optimization-based method, and the non-parametric method. According to an embodiment, the present disclosure describes a method of performing optimization-based meta learning at low feedback cost from a meta learning perspective for a transmitter.

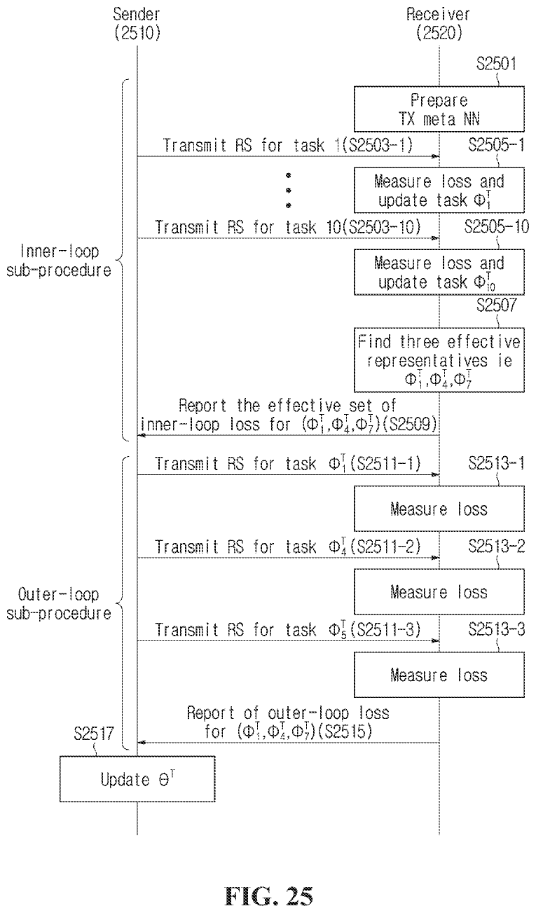

FIG. 25 illustrates another example of a procedure for performing meta learning for a transmitter according to an embodiment of the present disclosure. FIG. 25 exemplifies signaling between a transmitter 2510 and a receiver 2520. FIG. 25 exemplifies a case where 10 tasks are used.

Referring to FIG. 25, at step S2501, the receiver 2520 secures a TX meta neural network through an identifier in a TX meta request message. At steps S2503-1 to S2503-10, the transmitter 2510 transmits reference signals for 10 RS tasks. At steps S2505-1 to S2505-10, the receiver 2520 performs inner-loop evaluation for the 10 RS tasks, measures loss, and secures

$$\{ {ϕ}_{1}^{T} , {ϕ}_{2}^{T} , … {ϕ}_{10}^{T} \} .$$

Herein, task model parameters for the 10 tasks may be determined as shown in Formula 8.

φᵢ^{T}=θ^{T}−α∇_{θ}_{^{r}}L)(θ^{T},φ^{R}) [Formula 8]

In Formula 9, φᵢ^{T} means a task model parameter of a transmitter for a task i, θ^{T} means a meta model parameter of the transmitter, α means an update weight, θ^{T} means a meta model parameter of the transmitter, and φ^{R} means a task model parameter of a receiver.

In order to effectively extract a representative task, the receiver 2520 may extract 3 out of 10 tasks by using a clustering algorithm. Thus, when the receiver 2520 clusters and extracts three tasks with best generalization performance for

$$\{ {ϕ}_{1}^{T} , {ϕ}_{2}^{T} , … {ϕ}_{10}^{T} \} .$$

by using the proposed technique, the receiver 2520 may transfer loss only for representative

$${ϕ}_{1}^{T} , {ϕ}_{4}^{T} , {ϕ}_{7}^{T}$$

to the transmitter. Accordingly, the transmitter 2510 may determine the meta model parameter θ* without significant error. Then, in an outer loop, update may be performed only for those tasks.

Specifically, at steps S2511-1, S2511-2 and S2511-3, the transmitter 2510 transmits reference signals for a task 1, a task 4, and a task 7. At steps S2513-1, S2513-2 and S2513-3, the receiver 2520 measures loss. At step S2515, the receiver 2520 gives feedback on outer-loop loss. At step S2517, the transmitter 2510 updates a meta model parameter. Herein, the meta model parameter may be updated as shown in Formula 9 below.

$${θ}^{T} = {θ}^{T} - {( β ∇ )}_{{θ}^{T}} {\sum }_{i = 1 , 4 , 7} L ( {ϕ}_{i}^{T} , {ϕ}^{R} ) \qquad [ Formula 9 ]$$

In Formula 9, θ^{T} means a meta model parameter of a transmitter, β means an update weight,

$${ϕ}_{i}^{T}$$

means a task model parameter of the transmitter for a task i, and φ^{R} means a task model parameter of a receiver.

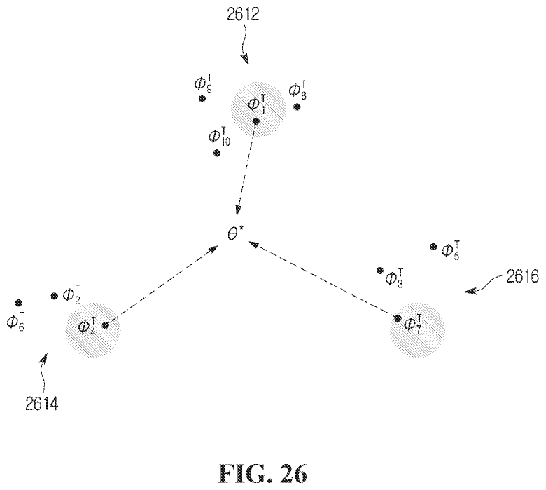

In the embodiment described by referring to FIG. 25, the receiver extracts 3 out of 10 tasks by using a clustering algorithm. As for a metric for clustering, Kullback-Libler divergence between any two φ may be used. For example, clustering may be performed in a parameter space, as shown in FIG. 26. FIG. 26 illustrates an example of clustering for model parameters according to an embodiment of the present disclosure. Referring to FIG. 26, 10 tasks are classified into 3 groups 2612, 2614 and 2616. Herein, one representative task is selected from each group, and a receiver may give feedback on loss values for the selected representative task of each group to a transmitter.

Herein, a representative task of each group may be differently selected according to a clustering algorithm used for selection. According to an embodiment, a task with a closest model parameter to an average value of a corresponding group may be selected as a representative task. According to another embodiment, a task with a smallest deviation of distance from other tasks within a group may be selected as a representative task. For example, a distance between tasks may be determined based on a probability distribution distance or Kullback-Leibler divergence (KLD).

In the above-described embodiments, only one task is selected from each group. However, according to another embodiment, a plurality of tasks may be selected from at least one group. For example, depending on a number of tasks belonging to a group, a number of representative tasks selected from the group may be different. Alternatively, depending on a total number of tasks, a plurality of representative tasks may be selected from at least one group.

As described above, the present disclosure proposes a method for performing online meta learning for neural networks at both sides amid changes in TX channel and RX channel in a wireless communication system where a transmitter and a receiver are implemented as the neural networks and an end-to-end message is transferred using the neural networks. In particular, the present disclosure shows a method for minimizing feedback cost for meta online learning of the transmitter. As the receiver evaluates a meta neural network of the transmitter from a RS task in an inner loop, a valid task may be selected, and only some tasks thus selected may be used to transfer loss for training to the transmitter, thereby reducing feedback cost. The valid task may be selected through clustering for a parameter set that is obtained from the inner loop. By selecting a representative task parameter, an error for a meta parameter may be minimized, and the advantage of meta learning may be maximized.

Examples of the above-described proposed methods may be included as one of the implementation methods of the present disclosure and thus may be regarded as kinds of proposed methods. In addition, the above-described proposed methods may be independently implemented or some of the proposed methods may be combined (or merged). The rule may be defined such that the base station informs the UE of information on whether to apply the proposed methods (or information on the rules of the proposed methods) through a predefined signal (e.g., a physical layer signal or a higher layer signal).

Those skilled in the art will appreciate that the present disclosure may be carried out in other specific ways than those set forth herein without departing from the spirit and essential characteristics of the present disclosure. The above exemplary embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. Moreover, it will be apparent that some claims referring to specific claims may be combined with another claims referring to the other claims other than the specific claims to constitute the embodiment or add new claims by means of amendment after the application is filed.

### INDUSTRIAL APPLICABILITY

The embodiments of the present disclosure are applicable to various radio access systems. Examples of the various radio access systems include a 3rd generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

1. A method performed by a user equipment (UE) in a wireless communication system, the method comprising:
receiving configuration information related to reference signals;
receiving first reference signals;
transmitting first feedback information corresponding to the first reference signals;
receiving second reference signals; and
transmitting second feedback information corresponding to the second reference signals,
wherein the first reference signals and the second reference signals are used to configure at least one parameter related to a receiver for processing a received signal, and
wherein the configuration information includes at least one of tasks used for meta learning, a batch size for training, an optimizing method for a parameter of a model in the receiver, at least one task used for an inner loop, or at least one task used for an outer loop.

2. The method of claim 1, wherein the first feedback information includes loss information that is used to configure at least one parameter related to a transmitter of a base station.

3. The method of claim 1, further comprising:
determining task model parameters for each of a plurality of tasks by using the first reference signals; and
determining a meta model parameter based on the task model parameters.

4. The method of claim 1, wherein the first feedback information includes loss information related to at least one task among a plurality of tasks corresponding to the first reference signals.

5. The method of claim 4, further comprising:
identifying transmitter neural networks of a base station for the plurality of tasks;
determining task model parameters for the transmitter neural networks based on the first reference signals and the transmitter neural networks; and
determining the at least one task based on the task model parameters.

6. The method of claim 5, further comprising:
classifying the task model parameters for the transmitter neural networks into a plurality of groups by clustering the task model parameters; and
determining the at least one task by selecting at least one task in each of the groups.

7. The method of claim 5, wherein the configuration information further includes information related to the transmitter neural networks.

8. The method of claim 1, wherein the first reference signals are used to determine task model parameters for each task by being used for an inner loop of the meta learning, and
wherein the second reference signals are used to determine a meta model parameter by being used for an outer loop of the meta learning.

9. A method performed by a base station in a wireless communication system, the method comprising:
transmitting configuration information related to reference signals;
transmitting first reference signals;
receiving first feedback information corresponding to the first reference signals;
transmitting second reference signals; and
receiving second feedback information corresponding to the second reference signals,
wherein the first reference signals and the second reference signals is used to configure at least one parameter related to a transmitter for processing a transmitted signal, and
wherein the configuration information includes at least one of tasks used for meta learning, a batch size for training, an optimizing method for a parameter of a model in a receiver of a user equipment (UE), at least one task used for an inner loop, or at least one task used for an outer loop.

10. The method of claim 9, wherein the first feedback information includes loss information that is used to configure at least one parameter related to a transmitter of a base station.

11. The method of claim 9, further comprising:
determining task model parameters for each of a plurality of tasks by using the loss information in the first feedback information; and
determining a meta model parameter based on loss information in the second feedback information and the task model parameters.

12. The method of claim 9, wherein the first feedback information includes loss information related to at least one task among a plurality of tasks corresponding to the first reference signals.

13. The method of claim 9, wherein the configuration information further includes information related to transmitter neural networks of the base station.

14. The method of claim 9, wherein the first reference signals are used to determine task model parameters for each task by being used for an inner loop of the meta learning, and
wherein the second reference signals are used to determine a meta model parameter by being used for an outer loop of the meta learning.

15. A user equipment (UE) in a wireless communication system, the UE comprising:
a transceiver; and
a processor coupled with the transceiver,
wherein the processor is configured to:
receive configuration information related to reference signals,
receive first reference signals,
transmit first feedback information corresponding to the first reference signals,
receive second reference signals, and
transmit second feedback information corresponding to the second reference signals,
wherein the first reference signals and the second reference signals are used to configure at least one parameter related to a receiver for processing a received signal, and
wherein the configuration information includes at least one of tasks used for meta learning, a batch size for training, an optimizing method for a parameter of a model in the receiver, at least one task used for an inner loop, or at least one task used for an outer loop.

16-18. (canceled)
